(19) United States
(12) Patent Application Publication
(10) Pub. No.: US 2018/0291713 A1
(43) Pub. Date: Oct. 11, 2018

(54) Field Equipment Model Driven System

(71) Applicant: Schlumberger Technology Corporation, Sugar Land, TX (US)

(72) Inventor: Eric Jeanson, Richmond, TX (US)

(21) Appl. No.: 15/762,080

(22) PCT Filed: Sep. 22, 2016
(86) PCT No.: PCT/US2016/052972

§ 371 Date: Mar. 21, 2018

Related U.S. Application Data
(60) Provisional application No. 62/284,271, filed on Sep. 24, 2015.

(51) Int. Cl. E21B 41/00; E21B 43/12; E21B 43/116; E21B 19/00; E21B 47/00; G06F 8/41; G05B 19/02

(52) U.S. Cl. CPC E21B 41/0092; E21B 43/128; E21B 43/116; E21B 43/26; E21B 47/0007; G06F 8/41; G05B 19/02; E21B 19/008

(57) ABSTRACT

A method can include receiving domain specific language that expresses a model of a field equipment system that includes data acquisition equipment; compiling the domain specific language to executable code; controlling at least a portion of the field equipment system by executing the executable code; and receiving data acquired by the data acquisition equipment responsive to executing at least a portion of the executable code.

### RELATED APPLICATION

This application claims priority to and the benefit of a US Provisional Application having Ser. No. 62/284,271, filed 24 Sep. 2015, which is incorporated by reference herein.

### BACKGROUND

Field operations can utilize various types of equipment, which can include surface equipment and/or downhole equipment. As an example, equipment may be moved from one site to another site, from one bore in a geologic environment to another bore, etc. Data acquired before, during and/or after a field operation may be analyzed, stored, etc.

### SUMMARY

In accordance with some embodiments, a method includes receiving domain specific language that expresses a model of a field equipment system that includes data acquisition equipment; compiling the domain specific language to executable code; controlling at least a portion of the field equipment system by executing at least a portion of the executable code; and receiving data acquired by the data acquisition equipment responsive to executing at least a portion of the executable code.

In some embodiments, an aspect of a method includes a field equipment system that includes a perforating gun where domain specific language includes expressions for actuation of at least one charge using the perforating gun.

In some embodiments, an aspect of a method includes a field equipment system that includes a wireline where domain specific language includes expressions for conveyance of the wireline in a bore in a geologic environment.

In some embodiments, an aspect of a method includes a field equipment system that includes an electric submersible pump where domain specific language includes expressions for acquisition of data from a gauge operatively coupled to the electric submersible pump, optionally where the field equipment system includes a drive operatively coupled to the electric submersible pump and where the domain specific language includes expressions for control of the electric submersible pump via the drive.

In some embodiments, an aspect of a method includes a domain specific language that includes expressions for regulatory compliance.

In some embodiments, an aspect of a method includes a domain specific language that includes sub-domain expressions, optionally where the sub-domain expressions include communication sub-domain expressions and data acquisition sub-domain expressions and optionally where the sub-domain expressions include control sub-domain expressions for control of at least a portion of the field equipment system at least in part via data acquired by the data acquisition equipment.

In some embodiments, an aspect of a method includes modifying domain specific language to create modified domain specific language and compiling the modified domain specific language, optionally where modifying includes adding at least one expression for an additional piece of equipment added to the field equipment system.

In some embodiments, an aspect of a method includes tapping into at least one communication channel of field equipment system.

In accordance with some embodiments, a computing system includes a processor; memory operatively coupled to the processor; and processor-executable instructions stored in the memory where the processor-executable instructions include instructions to instruct the system to: receive domain specific language that expresses a model of a field equipment system that includes data acquisition equipment; compile the domain specific language to executable code; control at least a portion of the field equipment system by execution of at least a portion of the executable code; and receive data from the data acquisition equipment responsive to execution of at least a portion of the executable code.

In some embodiments, an aspect of a system includes at least one interface operatively coupled to data acquisition equipment of a field equipment system.

In some embodiments, an aspect of a system includes at least one set of graphical user interface instructions executable to render graphical representations of data acquisition equipment to a display, optionally where the graphical representations have associated domain specific language.

In some embodiments, an aspect of a system includes domain specific language that expresses model states that represent operational states of a field equipment system.

In accordance with some embodiments, one or more computer-readable storage media include computer-executable instructions executable a computing device where the instructions include instructions to instruct the computing device to: receive domain specific language that expresses a model of a field equipment system that includes data acquisition equipment; compile the domain specific language to executable code; control at least a portion of the field equipment system by execution of at least a portion of the executable code; and receive data from the data acquisition equipment responsive to execution of at least a portion of the executable code.

In some embodiments, an aspect of one or more computer-readable storage media includes communication compilation instructions that compile at least a portion of domain specific language to executable code that controls communication along at least one communication channel of a field equipment system.

In some embodiments, an aspect of of one or more computer-readable storage media includes compilation instructions for at least one sensor that compile at least a portion of domain specific language to executable code that controls data acquisition by at least one sensor of a field equipment system.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates examples of equipment in a geologic environment;

FIG. 2 illustrates examples of equipment;

FIG. 3 illustrates examples of equipment with respect to a geologic environment with respect to an example of a method;

FIG. 4 illustrates examples of equipment with respect to a geologic environment with respect to an example of a method;

FIG. 5 illustrates an example of a system;

FIG. 6 illustrates an example of a method and examples of files and information handling equipment;

FIG. 7 illustrates an example of a system;

FIG. 8 illustrates examples of systems;

FIG. 9 illustrates examples of methods;

FIG. 10 illustrates an example of an architecture and an example of a method;

FIG. 11 illustrates an example of an architecture and an example of a method;

FIG. 12 illustrates an example of a method;

FIG. 13 illustrates an example of domain specific language and an example of a graphical user interface;

FIG. 14 illustrates an example of domain specific language and an example of a method;

FIG. 15 illustrates an example of a method and an example of a system;

FIG. 16 illustrates an example of a field equipment system and an example of a computing system;

FIG. 17 illustrates an example of a system, an example of a client layer and examples of field equipment; and

FIG. 18 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, field operations (e.g., field equipment operations) can utilize various types of equipment, which can include surface equipment and/or downhole equipment. Such equipment may be operatively coupled to remote equipment, for example, via one or more networks. Data acquired before, during and/or after a field operation may be analyzed, stored, etc.

As to a field, as described herein, a field is a hydrocarbon field that includes hydrocarbons in one or more subterranean formations. As an example, a hydrocarbon field can include one or more hydrocarbon reservoirs. As an example, hydrocarbons can include oil and/or gas hydrocarbons.

As to data acquisition, a system may be implemented at least in part on-site that interfaces with equipment, which can include one or more sensors. Data acquired by such a system may be transmitted to a remote site for analysis, decision making, etc. Such a data acquisition system may include instruction modules that have been developed over some period of time and validated as to their reliability and ability to interoperate with on-site equipment as well as to transmit data, whether raw or processed, to one or more remote sites. Where a situation changes at a site that calls for additional operations (e.g., optionally using additional equipment), a data acquisition system may be a rate limiting factor in carrying out one or more of such operations. For example, where a new piece of equipment is introduced to perform an operation, the data acquisition system may depend on additional instructions, which may be expected to operate without impacting reliability of existing instructions for particular tasks. In such an example, a validation process that validates performance of the instructions with respect to associated equipment may introduce a delay before the one or more additional operations can be carried out.

Further, as mentioned, equipment may be moved from one site to another site, from one bore in a geologic environment to another bore, etc. At a site, arrangements of equipment may differ. For example, at a first site, an electric submersible pump (ESP) may be driven by a fixed speed drive while at a second site the ESP may be driven by a variable speed drive. Where modules of a data acquisition system are particular to a fixed speed drive (e.g., validated, etc.), if that system is to be implemented at the second site, one or more modules may be swapped, adjusted, reprogrammed, etc., which may depend on performing a validation prior to on-site implementation.

As another example, consider a perforation gun that is loaded with charges suitable for one type of liner at a first site where the perforation gun is to be used for another type of liner at a second site. In such an example, charges may be formulated to tolerances to ensure that a liner collapses to form a desired jet. Where the charges for the first site are unsuitable for the second site, various operational factors may be impacted and an executable module for operating the perforation gun at the first site may be unsuitable for operating the perforation gun at the second site. Such site differences may cause delays as modules may be changed, validated, etc.

To facilitate operations, a model driven acquisition system may be implemented. For example, a method can include generating software code based on a definition of an acquisition system and communication model or grammar describing an acquisition supporting one or more communication protocols, data storage, computations, visualization, deliverables, etc.

As an example, consider a wireline acquisition system. Such a system may be suitable for implementation in one or more geologic environments. As an example, a deepwater integrated wireline conveyance system may be utilized that includes data acquisition capabilities. As an example, such a system may be expected to be safe, efficient, reliable, and avoid sticking. Further, regulatory aspects of equipment, operation of equipment, etc., may be relevant and, for example, site-specific. As an example, a wireline acquisition system for offshore use may be expected to be compliant with relevant international offshore regulations. As an example, a wireline acquisition system may include a wireline pulling rating, which may be dictated by one or more regulations, for example, to help minimize operational and HSE risk.

As an example, a wireline setup process may be implemented during deepwater rig construction, movement, or on arrival to location. Such a process may include one or more flying in one or more teams of rig installation experts. Depending on site specifics, so-called “reengineering” may take place on site, for example, such that a wireline conveyance can integrate desired system components. For example, an integrated set-up can include operative coupling of surface equipment through cable to sensor equipment.

Conveyance of wireline and associated equipment, whether onshore or offshore, can include operating drums, which may be tension and winch speed rated. Factors that may impact how conveyance is performed can include well geometry, well depth, geologic environment, etc. As an example, a deep, deviated well can pose safety and logistics concerns. To help to ensure that operating challenges are met, a planning framework may be utilized (e.g., consider the WELL CONVEYANCE PLANNER™ framework, Schlumberger Limited, Houston, Tex.). Such a framework may help to forecast logging tensions, provide design recommendations, and determine associated risk to configure an integrated conveyance system for a specific well environment. As an example, conveyance may be in a completed bore and/or in an uncompleted bore. As an example, an operation may include logging-while-tractoring, for example, to acquire data in both up and down passes.

As an example, a field operation may depend on input from domain experts. For example, for a wireline data acquisition system, a domain expert on conveyance, a domain expert on data transmission, a domain expert on safety and a domain expert on regulations may provide input. A model of such a field operation may include a module for conveyance, a module for data transmission, a module for safety and a module for regulations. Such a model may be multi-faceted, yet, for example, expressed in one or more domain specific languages.

As an example, a domain specific language may cover a field operation such as wireline data acquisition. In such an example, the domain specific language can include syntaxes or grammars for sub-domains that conform to an overarching syntax or grammar such that sub-domains can interconnect. As an example, a syntax or grammar for a sub-domain may be developed by one or more experts in that sub-domain. The overarching syntax or grammar may be understandable to experts in the various sub-domains.

As an example, a model expressed via a domain specific language may assist in making site specific adjustments, for example, whereby one or more operators can directly use the domain specific language to make modifications to a model. As an example, a domain specific language may be platform independent and/or suitable for multi-platform implementation (e.g., across different communication channels, different operating systems, etc.). As an example, domain knowledge may be specified at an appropriate level of abstraction through use of a domain specific language. Further, a domain specific language may facilitate understanding and validation, for example, optionally by domain experts.

As an example, a domain specific language may be implemented in a framework that can include one or more graphical user interfaces (GUI), which may, for example, operate as editors (e.g., model development editors, etc.). Such interfaces may provide for graphically coupling abstractions of equipment, communication, regulations, etc. For example, a drag-n-drop approach may provide a menu from which abstractions can be dragged and dropped onto a model field and operatively coupled by communication channels, logic, etc. In such an example, validation may be facilitated by examining the model as rendered to the model field of a GUI. As an example, an expert may be off-site where a model generated may be transmitted to the expert for validation. Such a process may include one or more validation techniques that act to prohibit implementation of the model prior to validation. For example, an expert may provide a certificate (e.g., digital signature, key, etc.), that allows for compilation of the model as expressed in a domain specific language to generate executable code that can be implemented in conjunction with a data acquisition system (e.g., for conveyance, for data acquisition, for control, for communications, for data analysis, etc.).

As an example, a method can include generating software (e.g., automated code generation) based on a domain specific language (DSL) that defines one or more of communication (e.g., acquisition and control), storage, visualization and deliverable models. Such a method may help to ensure that software generated is to be consistent and that it allows different automated transformations to target specific implementations such as high reliability (high stability fault tolerant implementation) and/or high performance (highly optimized code) through the definition of a strategy.

As an example, automatically generated software may be bundled with acquisition framework software deployed to a field location, where the system may be able to establish interactions with equipment (e.g., surface and downhole) to accomplish one or more operations.

As an example, a domain specific approach may reduce human (developer) error in generating communication software, which may be considered to be an area sensitive to errors. For example, in a real-time acquisition system small errors may be time consuming to uncover (e.g., troubleshoot, reproduce, etc.).

As an example, a domain specific approach may provide one or more extensible patterns by which a model describes approaches of storing, displaying and delivering data. As an example, a domain specific approach may be scalable, for example, allowing for addition of equipment, storage, visualization and deliverables.

As an example, a domain specific approach may be optimized, for example, for different ways to execute (e.g., high reliability, high performance, etc.) for two way communication protocol, data storage, visualization and deliverables.

As an example, a domain specific approach may be agnostic in that it may be targeted by one or more compilers to different types of executable code. For example, generated code for a model expressed in a domain specific language can target one or more of a plurality of different technology stacks, operating systems, including one or more sub-systems being generated for different architecture (windows, computation clusters, etc.).

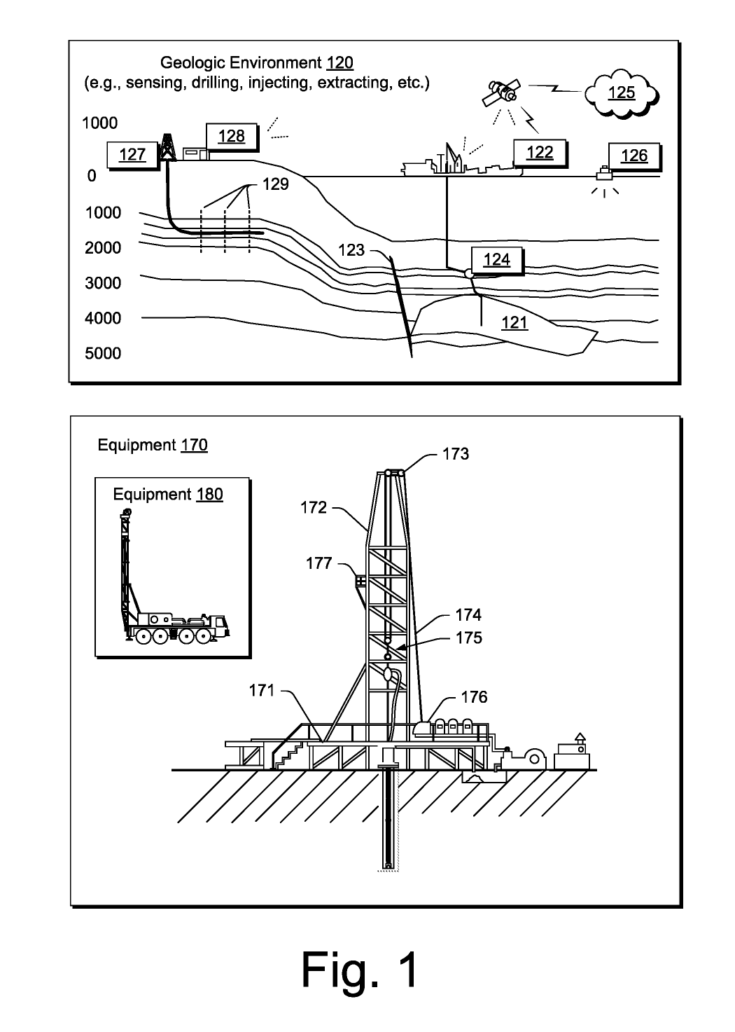

FIGS. 1, 2, 3, 4 and 5 shows examples of various equipment in various geologic environments. As an example, a domain specific approach to a model driven acquisition system may be implemented for such equipment. As an example, a model driven acquisition system may be implemented for one or more tasks, including one or more of, for example, data analysis, control, etc.

FIG. 1 shows an example of a geologic environment 120. In FIG. 1, the geologic environment 120 may be a sedimentary basin that includes layers (e.g., stratification) that include a reservoir 121 and that may be, for example, intersected by a fault 123 (e.g., or faults). As an example, the geologic environment 120 may be outfitted with any of a variety of sensors, detectors, actuators, etc. For example, equipment 122 may include communication circuitry to receive and to transmit information with respect to one or more networks 125. Such information may include information associated with downhole equipment 124, which may be equipment to acquire information, to assist with resource recovery, etc. Other equipment 126 may be located remote from a well site and include sensing, detecting, emitting or other circuitry. Such equipment may include storage and communication circuitry to store and to communicate data, instructions, etc. As an example, one or more pieces of equipment may provide for measurement, collection, communication, storage, analysis, etc. of data (e.g., for one or more produced resources, etc.). As an example, one or more satellites may be provided for purposes of communications, data acquisition, etc. For example, FIG. 1 shows a satellite in communication with the network 125 that may be configured for communications, noting that the satellite may additionally or alternatively include circuitry for imagery (e.g., spatial, spectral, temporal, radiometric, etc.).

FIG. 1 also shows the geologic environment 120 as optionally including equipment 127 and 128 associated with a well that includes a substantially horizontal portion that may intersect with one or more fractures 129. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 127 and/or 128 may include components, a system, systems, etc. for fracturing, seismic sensing, analysis of seismic data, assessment of one or more fractures, injection, production, etc. As an example, the equipment 127 and/or 128 may provide for measurement, collection, communication, storage, analysis, etc. of data such as, for example, production data (e.g., for one or more produced resources). As an example, one or more satellites may be provided for purposes of communications, data acquisition, etc.

FIG. 1 also shows an example of equipment 170 and an example of equipment 180. Such equipment, which may be systems of components, may be suitable for use in the geologic environment 120. While the equipment 170 and 180 are illustrated as land-based, various components may be suitable for use in an offshore system.

The equipment 170 includes a platform 171, a derrick 172, a crown block 173, a line 174, a traveling block assembly 175, drawworks 176 and a landing 177 (e.g., a monkeyboard). As an example, the line 174 may be controlled at least in part via the drawworks 176 such that the traveling block assembly 175 travels in a vertical direction with respect to the platform 171. For example, by drawing the line 174 in, the drawworks 176 may cause the line 174 to run through the crown block 173 and lift the traveling block assembly 175 skyward away from the platform 171; whereas, by allowing the line 174 out, the drawworks 176 may cause the line 174 to run through the crown block 173 and lower the traveling block assembly 175 toward the platform 171. Where the traveling block assembly 175 carries pipe (e.g., casing, etc.), tracking of movement of the traveling block 175 may provide an indication as to how much pipe has been deployed.

A derrick can be a structure used to support a crown block and a traveling block operatively coupled to the crown block at least in part via line. A derrick may be pyramidal in shape and offer a suitable strength-to-weight ratio. A derrick may be movable as a unit or in a piece by piece manner (e.g., to be assembled and disassembled).

As an example, drawworks may include a spool, brakes, a power source and assorted auxiliary devices. Drawworks may controllably reel out and reel in line. Line may be reeled over a crown block and coupled to a traveling block to gain mechanical advantage in a “block and tackle” or “pulley” fashion. Reeling out and in of line can cause a traveling block (e.g., and whatever may be hanging underneath it), to be lowered into or raised out of a bore. Reeling out of line may be powered by gravity and reeling in by a motor, an engine, etc. (e.g., an electric motor, a diesel engine, etc.).

As an example, a crown block can include a set of pulleys (e.g., sheaves) that can be located at or near a top of a derrick or a mast, over which line is threaded. A traveling block can include a set of sheaves that can be moved up and down in a derrick or a mast via line threaded in the set of sheaves of the traveling block and in the set of sheaves of a crown block. A crown block, a traveling block and a line can form a pulley system of a derrick or a mast, which may enable handling of heavy loads (e.g., drillstring, pipe, casing, liners, etc.) to be lifted out of or lowered into a bore. As an example, line may be about a centimeter to about five centimeters in diameter as, for example, steel cable. Through use of a set of sheaves, such line may carry loads heavier than the line could support as a single strand.

As an example, a derrickman may be a rig crew member that works on a platform attached to a derrick or a mast. A derrick can include a landing on which a derrickman may stand. As an example, such a landing may be about 10 meters or more above a rig floor. In an operation referred to as trip out of the hole (TOH), a derrickman may wear a safety harness that enables leaning out from the work landing (e.g., monkeyboard) to reach pipe in located at or near the center of a derrick or a mast and to throw a line around the pipe and pull it back into its storage location (e.g., fingerboards), for example, until it a time at which it may be desirable to run the pipe back into the bore. As an example, a rig may include automated pipe-handling equipment such that the derrickman controls the machinery rather than physically handling the pipe.

As an example, a trip may refer to the act of pulling equipment from a bore and/or placing equipment in a bore. As an example, equipment may include a drillstring that can be pulled out of the hole and/or place or replaced in the hole. As an example, a pipe trip may be performed where a drill bit has dulled or has otherwise ceased to drill efficiently and is to be replaced.

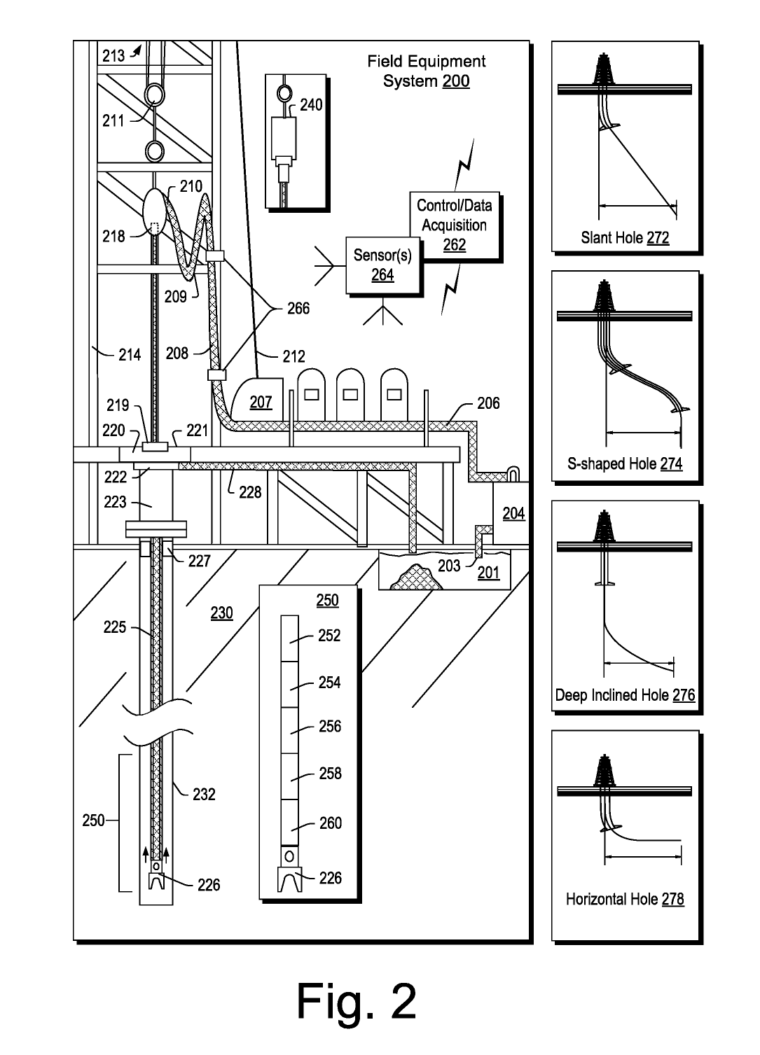

FIG. 2 shows an example of a field equipment system 200 (e.g., at a wellsite that may be onshore or offshore). As shown, the field equipment system 200 can include a mud tank 201 for holding mud and other material (e.g., where mud can be a drilling fluid), a suction line 203 that serves as an inlet to a mud pump 204 for pumping mud from the mud tank 201 such that mud flows to a vibrating hose 206, a drawworks 207 for winching drill line or drill lines 212, a standpipe 208 that receives mud from the vibrating hose 206, a kelly hose 209 that receives mud from the standpipe 208, a gooseneck or goosenecks 210, a traveling block 211, a crown block 213 for carrying the traveling block 211 via the drill line or drill lines 212 (see, e.g., the crown block 173 of FIG. 1), a derrick 214 (see, e.g., the derrick 172 of FIG. 1), a kelly 218 or a top drive 240, a kelly drive bushing 219, a rotary table 220, a drill floor 221, a bell nipple 222, one or more blowout preventors (BOPs) 223, a drillstring 225, a drill bit 226, a casing head 227 and a flow pipe 228 that carries mud and other material to, for example, the mud tank 201.

In the example system of FIG. 2, a borehole 232 is formed in subsurface formations 230 by rotary drilling; noting that various example embodiments may also use directional drilling.

As shown in the example of FIG. 2, the drillstring 225 is suspended within the borehole 232 and has a drillstring assembly 250 that includes the drill bit 226 at its lower end. As an example, the drillstring assembly 250 may be a bottom hole assembly (BHA).

The field equipment system 200 can provide for operation of the drillstring 225 and other operations. As shown, the field equipment system 200 includes the platform 211 and the derrick 214 positioned over the borehole 232. As mentioned, the field equipment system 200 can include the rotary table 220 where the drillstring 225 pass through an opening in the rotary table 220.

As shown in the example of FIG. 2, the field equipment system 200 can include the kelly 218 and associated components, etc., or a top drive 240 and associated components. As to a kelly example, the kelly 218 may be a square or hexagonal metal/alloy bar with a hole drilled therein that serves as a mud flow path. The kelly 218 can be used to transmit rotary motion from the rotary table 220 via the kelly drive bushing 219 to the drillstring 225, while allowing the drillstring 225 to be lowered or raised during rotation. The kelly 218 can pass through the kelly drive bushing 219, which can be driven by the rotary table 220. As an example, the rotary table 220 can include a master bushing that operatively couples to the kelly drive bushing 219 such that rotation of the rotary table 220 can turn the kelly drive bushing 219 and hence the kelly 218. The kelly drive bushing 219 can include an inside profile matching an outside profile (e.g., square, hexagonal, etc.) of the kelly 218; however, with slightly larger dimensions so that the kelly 218 can freely move up and down inside the kelly drive bushing 219.

As to a top drive example, the top drive 240 can provide functions performed by a kelly and a rotary table. The top drive 240 can turn the drillstring 225. As an example, the top drive 240 can include one or more motors (e.g., electric and/or hydraulic) connected with appropriate gearing to a short section of pipe called a quill, that in turn may be screwed into a saver sub or the drillstring 225 itself. The top drive 240 can be suspended from the traveling block 211, so the rotary mechanism is free to travel up and down the derrick 214. As an example, a top drive 240 may allow for drilling to be performed with more joint stands than a kelly/rotary table approach.

In the example of FIG. 2, the mud tank 201 can hold mud, which can be one or more types of drilling fluids. As an example, a wellbore may be drilled to produce fluid, inject fluid or both (e.g., hydrocarbons, minerals, water, etc.).

In the example of FIG. 2, the drillstring 225 (e.g., including one or more downhole tools) may be composed of a series of pipes threadably connected together to form a long tube with the drill bit 226 at the lower end thereof. As the drillstring 225 is advanced into a wellbore for drilling, at some point in time prior to or coincident with drilling, the mud may be pumped by the pump 204 from the mud tank 201 (e.g., or other source) via a the lines 206, 208 and 209 to a port of the kelly 218 or, for example, to a port of the top drive 240. The mud can then flow via a passage (e.g., or passages) in the drillstring 225 and out of ports located on the drill bit 226 (see, e.g., a directional arrow). As the mud exits the drillstring 225 via ports in the drill bit 226, it can then circulate upwardly through an annular region between an outer surface(s) of the drillstring 225 and surrounding wall(s) (e.g., open borehole, casing, etc.), as indicated by directional arrows. In such a manner, the mud lubricates the drill bit 226 and carries heat energy (e.g., frictional or other energy) and formation cuttings to the surface where the mud (e.g., and cuttings) may be returned to the mud tank 201, for example, for recirculation (e.g., with processing to remove cuttings, etc.).

The mud pumped by the pump 204 into the drillstring 225 may, after exiting the drillstring 225, form a mudcake that lines the wellbore which, among other functions, may reduce friction between the drillstring 225 and surrounding wall(s) (e.g., borehole, casing, etc.). A reduction in friction may facilitate advancing or retracting the drillstring 225. During a drilling operation, the entire drill string 225 may be pulled from a wellbore and optionally replaced, for example, with a new or sharpened drill bit, a smaller diameter drill string, etc. As mentioned, the act of pulling a drill string out of a hole or replacing it in a hole is referred to as tripping. A trip may be referred to as an upward trip or an outward trip or as a downward trip or an inward trip depending on trip direction.

As an example, consider a downward trip where upon arrival of the drill bit 226 of the drill string 225 at a bottom of a wellbore, pumping of the mud commences to lubricate the drill bit 226 for purposes of drilling to enlarge the wellbore. As mentioned, the mud can be pumped by the pump 204 into a passage of the drillstring 225 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may modulated. In such an example, information from downhole equipment (e.g., one or more modules of the drillstring 225) may be transmitted uphole to an uphole device, which may relay such information to other equipment for processing, control, etc.

As an example, telemetry equipment may operate via transmission of energy via the drillstring 225 itself. For example, consider a signal generator that imparts coded energy signals to the drillstring 225 and repeaters that may receive such energy and repeat it to further transmit the coded energy signals (e.g., information, etc.).

As an example, the drillstring 225 may be fitted with telemetry equipment 252 that includes a rotatable drive shaft, a turbine impeller mechanically coupled to the drive shaft such that the mud can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 2, an uphole control and/or data acquisition system 262 may include circuitry to sense pressure pulses generated by telemetry equipment 252 and, for example, communicate sensed pressure pulses or information derived therefrom for process, control, etc.

The assembly 250 of the illustrated example includes a logging-while-drilling (LWD) module 254, a measuring-while-drilling (MWD) module 256, an optional module 258, a roto-steerable system and motor 260, and the drill bit 226.

The LWD module 254 may be housed in a suitable type of drill collar and can contain one or a plurality of selected types of logging tools. It will also be understood that more than one LWD and/or MWD module can be employed, for example, as represented at by the module 256 of the drillstring assembly 250. Where the position of an LWD module is mentioned, as an example, it may refer to a module at the position of the LWD module 254, the module 256, etc. An LWD module can include capabilities for measuring, processing, and storing information, as well as for communicating with the surface equipment. In the illustrated example, the LWD module 254 may include a seismic measuring device.

The MWD module 256 may be housed in a suitable type of drill collar and can contain one or more devices for measuring characteristics of the drillstring 225 and the drill bit 226. As an example, the MWD tool 254 may include equipment for generating electrical power, for example, to power various components of the drillstring 225. As an example, the MWD tool 254 may include the telemetry equipment 252, for example, where the turbine impeller can generate power by flow of the mud; it being understood that other power and/or battery systems may be employed for purposes of powering various components. As an example, the MWD module 256 may include one or more of the following types of measuring devices: a weight-on-bit measuring device, a torque measuring device, a vibration measuring device, a shock measuring device, a stick slip measuring device, a direction measuring device, and an inclination measuring device.

FIG. 2 also shows some examples of types of holes that may be drilled. For example, consider a slant hole 272, an S-shaped hole 274, a deep inclined hole 276 and a horizontal hole 278.

As an example, a drilling operation can include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees.

As an example, a directional well can include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of a downhole motor and/or a turbine. As to a motor, for example, a drillstring can include a positive displacement motor (PDM).

As an example, a system may be a steerable system and include equipment to perform method such as geosteering. As an example, a steerable system can include a PDM or of a turbine on a lower part of a drillstring which, just above a drill bit, a bent sub can be mounted. As an example, above a PDM, MWD equipment that provides real time or near real time data of interest (e.g., inclination, direction, pressure, temperature, real weight on the drill bit, torque stress, etc.) and/or LWD equipment may be installed. As to the latter, LWD equipment can make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, can allow for implementing a geosteering method. Such a method can include navigating a subsurface environment, for example, to follow a desired route to reach a desired target or targets.

As an example, a drillstring can include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

As an example, geosteering can include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 2, the field equipment system 200 can include one or more sensors 264 that are operatively coupled to the control and/or data acquisition system 262. As an example, a sensor or sensors may be at surface locations. As an example, a sensor or sensors may be at downhole locations. As an example, a sensor or sensors may be at one or more remote locations that are not within a distance of the order of about one hundred meters from the field equipment system 200. As an example, a sensor or sensor may be at an offset wellsite where the field equipment system 200 and the offset wellsite are in a common field (e.g., oil and/or gas field).

As an example, one or more of the sensors 264 can be provided for tracking pipe, tracking movement of at least a portion of a drillstring, etc.

As an example, the system 200 can include one or more sensors 266 that can sense and/or transmit signals to a fluid conduit such as a drilling fluid conduit (e.g., a drilling mud conduit). For example, in the system 200, the one or more sensors 266 can be operatively coupled to portions of the standpipe 208 through which mud flows. As an example, a downhole tool can generate pulses that can travel through the mud and be sensed by one or more of the one or more sensors 266. In such an example, the downhole tool can include associated circuitry such as, for example, encoding circuitry that can encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 200 can include a transmitter that can generate signals that can be transmitted downhole via mud (e.g., drilling fluid) as a transmission medium.

As an example, one or more portions of a drillstring may become stuck. The term stuck can refer to one or more of varying degrees of inability to move or remove a drillstring from a bore. As an example, in a stuck condition, it might be possible to rotate pipe or lower it back into a bore or, for example, in a stuck condition, there may be an inability to move the drillstring axially in the bore, though some amount of rotation may be possible. As an example, in a stuck condition, there may be an inability to move at least a portion of the drillstring axially and rotationally.

As to the term “stuck pipe”, the can refer to a portion of a drillstring that cannot be rotated or moved axially. As an example, a condition referred to as “differential sticking” can be a condition whereby the drillstring cannot be moved (e.g., rotated or reciprocated) along the axis of the bore. Differential sticking may occur when high-contact forces caused by low reservoir pressures, high wellbore pressures, or both, are exerted over a sufficiently large area of the drillstring. Differential sticking can have time and financial cost.

As an example, a sticking force can be a product of the differential pressure between the wellbore and the reservoir and the area that the differential pressure is acting upon. This means that a relatively low differential pressure (delta p) applied over a large working area can be just as effective in sticking pipe as can a high differential pressure applied over a small area.

As an example, a condition referred to as “mechanical sticking” can be a condition where limiting or prevention of motion of the drillstring by a mechanism other than differential pressure sticking occurs. Mechanical sticking can be caused, for example, by one or more of junk in the hole, wellbore geometry anomalies, cement, keyseats or a buildup of cuttings in the annulus.

Equipment may include fracturing equipment where such equipment may be employed to generate one or more fractures in a geologic environment. As an example, a method to generate fractures can include a delivery block for delivering fluid to a subterranean environment, a monitor block for monitoring fluid pressure and a generation block for generating fractures via fluid pressure. As an example, the generation block may include activating one or more fractures. As an example, the generation block may include generating and activating fractures. As an example, activation may occur with respect to a pre-existing feature such as a fault or a fracture. As an example, a pre-existing fracture network may be at least in part activated via a method that includes applying fluid pressure in a subterranean environment. The foregoing method may be referred to as a treatment method or a “treatment”. Such a method may include pumping an engineered fluid (e.g., a treatment fluid) at high pressure and rate into a reservoir via one or more bores, for example, to one or more intervals to be treated, which may cause a fracture or fractures to open (e.g., new, pre-existing, etc.).

As an example, a fracture may be defined as including “wings” that extend outwardly from a bore. Such wings may extend away from a bore in opposing directions, for example, according in part to natural stresses within a formation. As an example, proppant may be mixed with a treatment fluid to keep a fracture (or fractures) open when a treatment is complete. Hydraulic fracturing may create high-conductivity communication with an area of a formation and, for example, may bypass damage that may exist in a near-wellbore area. As an example, stimulation treatment may occur in stages. For example, after completing a first stage, data may be acquired and analyzed for planning and/or performance of a subsequent stage.

Size and orientation of a fracture, and the magnitude of the pressure to create it, may be dictated at least in part by a formation's in situ stress field. As an example, a stress field may be defined by three principal compressive stresses, which are oriented perpendicular to each other. The magnitudes and orientations of these three principal stresses may be determined by the tectonic regime in the region and by depth, pore pressure and rock properties, which determine how stress is transmitted and distributed among formations.

Where fluid pressure is monitored, a sudden drop in pressure can indicate fracture initiation of a stimulation treatment, as fluid flows into the fractured formation. As an example, to break rock in a target interval, fracture initiation pressure exceeds a sum of the minimum principal stress plus the tensile strength of the rock. To determine fracture closure pressure, a process may allow pressure to subside until it indicates that a fracture has closed. A fracture reopening pressure may be determined by pressurizing a zone until a leveling of pressure indicates the fracture has reopened. The closure and reopening pressures tend to be controlled by the minimum principal compressive stress (e.g., where induced downhole pressures exceed minimum principal stress to extend fracture length).

After performing fracture initiation, a zone may be pressurized for furthering stimulation treatment. As an example, a zone may be pressurized to a fracture propagation pressure, which is greater than a fracture closure pressure. The difference may be referred to as the net pressure, which represents a sum of frictional pressure drop and fracture-tip resistance to propagation (e.g., further propagation).

As an example, a method may include seismic monitoring during a treatment operation (e.g., to monitor fracture initiation, growth, etc.). For example, as fracturing fluid forces rock to crack and fractures to grow, small fragments of rock break, causing tiny seismic emissions, called microseisms. Equipment may be positioned in a field, in a bore, etc. to sense such emissions and to process acquired data, for example, to locate microseisms in the subsurface (e.g., to locate hypocenters). Information as to direction of fracture growth may allow for actions that can “steer” a fracture into a desired zone(s) or, for example, to halt a treatment before a fracture grows out of an intended zone. Seismic information (e.g., information associated with microseisms) may be used to plan one or more stages of fracturing operations (e.g., location, pressure, etc.).

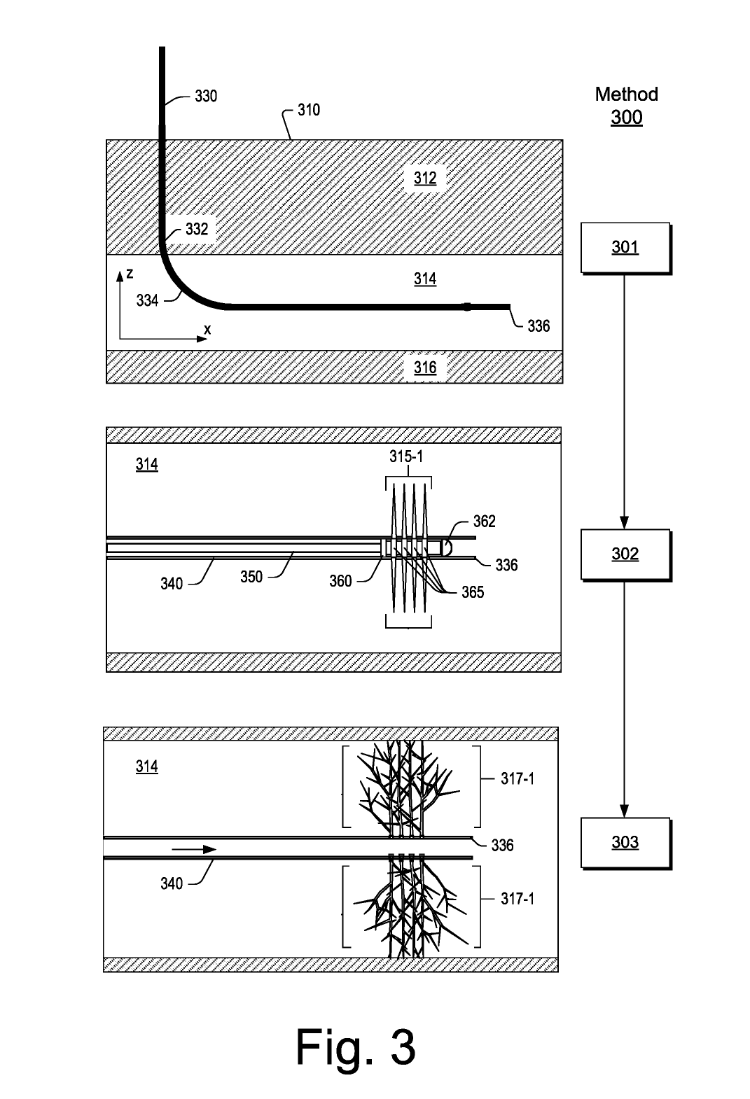

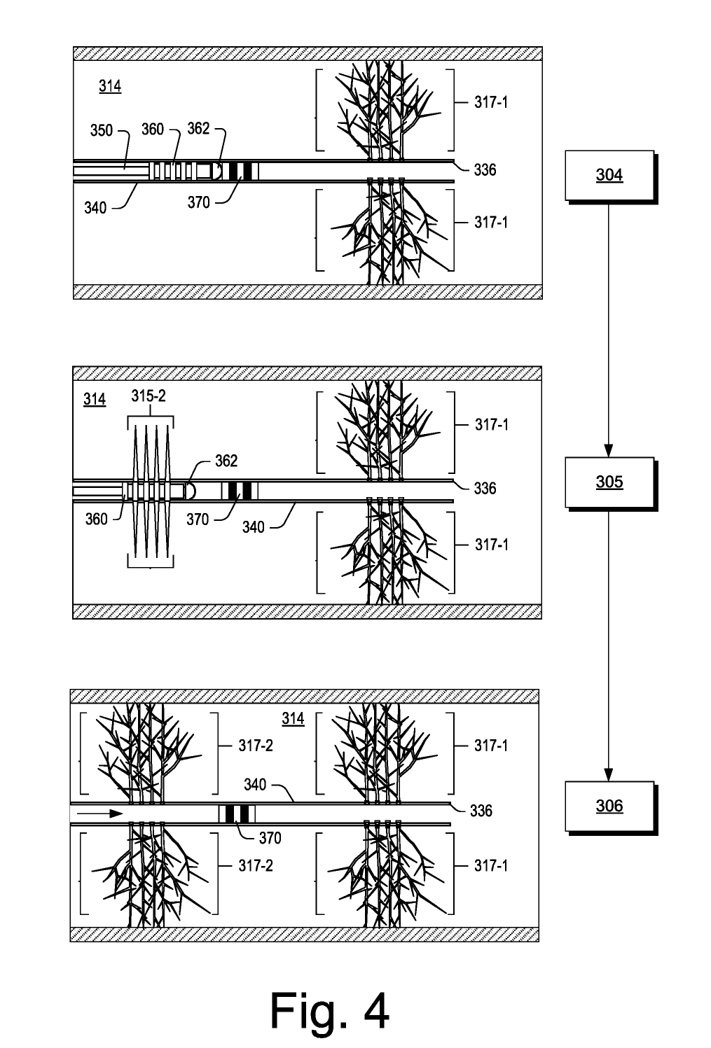

FIGS. 3 and 4 show an example of a method 300 that includes generating fractures. As shown, the method 300 can include various operational blocks such as one or more of the blocks 301, 302, 303, 304, 305 and 306. The block 301 may be a drilling block that includes drilling into a formation 310 that includes layers 312, 314 and 316 to form a bore 330 with a kickoff 332 to a portion defined by a heel 334 and a toe 336, for example, within the layer 314.

As illustrated with respect to the block 302, the bore 330 may be at least partially cased with casing 340 into which a string or line 350 may be introduced that carries a perforator 360 (e.g., a perforating gun, etc.). As shown, the perforator 360 can include a distal end 362 and charge positions 365 associated with activatable charges that can perforate the casing 340 and form channels 315-1 in the layer 314. Next, per the block 303, fluid may be introduced into the bore 330 between the heel 334 and the toe 336 where the fluid passes through the perforations in the casing 340 and into the channels 315-1. Where such fluid is under pressure, the pressure may be sufficient to fracture the layer 314, for example, to form fractures 317-1. In the block 303, the fractures 317-1 may be first stage fractures, for example, of a multistage fracturing operation.

Per the block 304, additional operations are performed for further fracturing of the layer 314. For example, a plug 370 may be introduced into the bore 330 between the heel 334 and the toe 336 and positioned, for example, in a region between first stage perforations of the casing 340 and the heel 334. Per the block 305, the perforator 360 may be activated to form additional perforations in the casing 340 (e.g., second stage perforations) as well as channels 315-2 in the layer 314 (e.g., second stage channels). Per the block 306, fluid may be introduced while the plug 370 is disposed in the bore 330, for example, to isolate a portion of the bore 330 such that fluid pressure may build to a level sufficient to form fractures 317-2 in the layer 314 (e.g., second stage fractures).

In a method such as the method 300 of FIGS. 3 and 4, it may be desirable that a plug (e.g., the plug 370) includes properties suited to one or more operations. Properties of a plug may include mechanical properties (e.g., sufficient strength to withstand pressure associated with fracture generation, etc.) and may include one or more other types of properties (e.g., chemical, electrical, etc.). As an example, it may be desirable that a plug degrades, that a plug seat degrades, that at least a portion of a borehole tool degrades, etc. For example, a plug may be manufactured with properties such that the plug withstands, for a period of time, conditions associated with an operation and then degrades (e.g., when exposed to one or more conditions). In such an example, where the plug acts to block a passage for an operation, upon degradation, the passage may become unblocked, which may allow for one or more subsequent operations.

As an example, a component may be degradable upon contact with a fluid such as an aqueous ionic fluid (e.g., saline fluid, etc.). As an example, a component may be degradable upon contact with well fluid that includes water (e.g., consider well fluid that includes oil and water, etc.). As an example, a component may be degradable upon contact with a fracturing fluid (e.g., a hydraulic fracturing fluid).

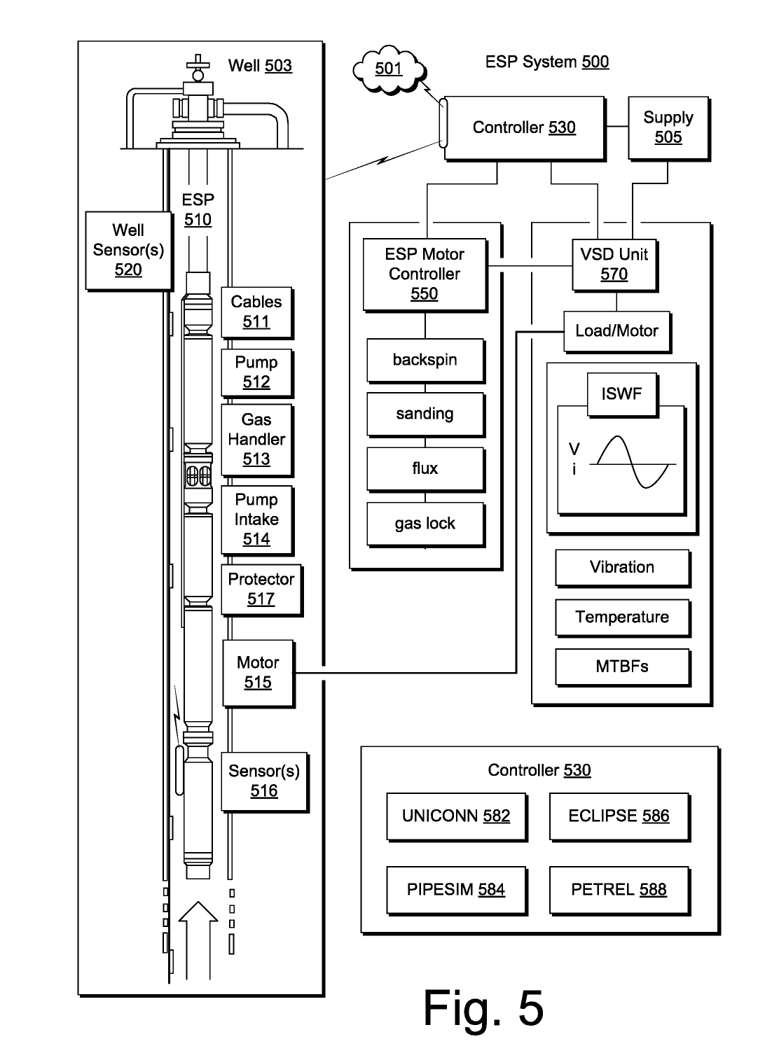

FIG. 5 shows an example of an ESP system 500 that includes an ESP 510 as an example of equipment that may be placed in a geologic environment. As an example, an ESP may be expected to function in an environment over an extended period of time (e.g., optionally of the order of years). As an example, commercially available ESPs (such as the REDA® ESPs marketed by Schlumberger Limited, Houston, Tex.) may find use in applications that call pump rates of the order of a thousand barrels per day or more. As an example, an ESP may be disposed in a bore to a desired distance (e.g., depth, etc.). As an example, an ESP may be disposed in a bore at a distance, for example, of more than a thousand meters.

In the example of FIG. 5, the ESP system 500 includes a network 501, a well 503 disposed in a geologic environment (e.g., with surface equipment, etc.), a power supply 505, the ESP 510, a controller 530, a motor controller 550 and a VSD unit 570. The power supply 505 may receive power from a power grid, an onsite generator (e.g., natural gas driven turbine), or other source. The power supply 505 may supply a voltage, for example, of about 4.16 kV.

As shown, the well 503 includes a wellhead that can include a choke (e.g., a choke valve). For example, the well 503 can include a choke valve to control various operations such as to reduce pressure of a fluid from high pressure in a closed wellbore to atmospheric pressure. Adjustable choke valves can include valves constructed to resist wear due to high-velocity, solids-laden fluid flowing by restricting or sealing elements. A wellhead may include one or more sensors such as a temperature sensor, a pressure sensor, a solids sensor, etc.

As to the ESP 510, it is shown as including cables 511 (e.g., or a cable), a pump 512, gas handling features 513, a pump intake 514, a motor 515, one or more sensors 516 (e.g., temperature, pressure, strain, current leakage, vibration, etc.) and optionally a protector 517.

As an example, an ESP motor can include a three-phase squirrel cage with two-pole induction. As an example, an ESP motor may include steel stator laminations that can help focus magnetic forces on rotors, for example, to help reduce energy loss. As an example, stator windings can include copper and insulation. As an example, a multiphase electric motor can include a wye point where phase conductors are electrically joined.

As an example, the one or more sensors 516 of the ESP 510 may be part of a digital downhole monitoring system. For example, consider the commercially available PHOENIX™ Multisensor xt150 system marketed by Schlumberger Limited (Houston, Tex.). As an example, a monitoring system such as the ENDURANT™ system may be included in an ESP system. As an example, a gauge or monitoring system may be operatively coupled to a wye point of a multiphase electric motor. In such an example, power may be received via the wye point (e.g., DC injected into one or more conductors of a multiphase power cable, etc.) and/or information may be transmitted via the wye point (e.g., via one or more conductors of a multiphase power cable, etc.).

A monitoring system may include a base unit that operatively couples to an ESP motor (see, e.g., the motor 515), for example, directly, via a motor-base crossover, etc. As an example, such a base unit (e.g., base gauge) may measure intake pressure, intake temperature, motor oil temperature, motor winding temperature, vibration, currently leakage, etc.

As an example, a remote unit may be provided that may be located at a pump discharge (e.g., located at an end opposite the pump intake 514). As an example, a base unit and a remote unit may, in combination, measure intake and discharge pressures across a pump (see, e.g., the pump 512), for example, for analysis of a pump curve. As an example, alarms may be set for one or more parameters (e.g., measurements, parameters based on measurements, etc.).

As an example, a remote unit may transmit sensed information to a base unit, which, in turn, may transmit such information to a surface unit via one or more electric motor conductors of a multiphase power cable configured to provide power to an ESP motor.

In the example of FIG. 5, the well 503 may include one or more well sensors 520, for example, such as the commercially available OPTICLINE™ sensors or WELLWATCHER BRITEBLUE™ sensors marketed by Schlumberger Limited (Houston, Tex.). Such sensors are fiber-optic based and can provide for real time sensing of temperature, for example, in SAGD or other operations.

In the example of FIG. 5, the controller 530 can include one or more interfaces, for example, for receipt, transmission or receipt and transmission of information with the motor controller 550, a VSD unit 570, the power supply 505 (e.g., a gas fueled turbine generator, a power company, etc.), the network 501, equipment in the well 503, equipment in another well, etc.

As shown in FIG. 5, the controller 530 may include or provide access to one or more modules or frameworks. Further, the controller 530 may include features of an ESP motor controller and optionally supplant the ESP motor controller 550. For example, the controller 530 may include the UNICONN™ motor controller 582 marketed by Schlumberger Limited (Houston, Tex.). In the example of FIG. 5, the controller 530 may access one or more of the PIPESIM® framework 584, the ECLIPSE® framework 586 marketed by Schlumberger Limited (Houston, Tex.) and the PETREL® framework 588 marketed by Schlumberger Limited (Houston, Tex.) (e.g., and optionally the OCEAN® framework marketed by Schlumberger Limited (Houston, Tex.)).

As an example, the UNICONN™ motor controller can interface with the aforementioned PHOENIX™ monitoring system, for example, to access pressure, temperature and vibration data and various protection parameters as well as to provide direct current power to downhole sensors.

As an example, a system may include one or more interface cards that include circuitry that can interface with a transmission line or lines associated with a monitoring system, sensor unit (e.g., a gauge), etc. For example, a system may include one or more PHOENIX™ interface cards (PICs), which may, for example, provide current (e.g., direct current) to electric motor conductors of a multiphase power cable that can be received by a sensor unit operatively coupled to a wye point of an electric motor.

As an example, an INSTRUCT™ acquisition and control unit (Schlumberger Limited, Houston, Tex.) may include one or more interface cards. As an example, an interface card may include circuitry that can receive signals as transmitted at least in part via a multiphase power cable that powers an electric motor where the signals include signals that originate at one sensor unit operatively coupled to a wye point of the electric motors.

For FSD controllers, the UNICONN™ motor controller can monitor ESP system three-phase currents, three-phase surface voltage, supply voltage and frequency, ESP spinning frequency and leg ground, power factor and motor load. As an example, a controller such as, for example, a FSD controller may implement control based in part on signals received via one or more ESP coupled sensor units.

For VSD units, the UNICONN™ motor controller can monitor VSD output current, ESP running current, VSD output voltage, supply voltage, VSD input and VSD output power, VSD output frequency, drive loading, motor load, three-phase ESP running current, three-phase VSD input or output voltage, ESP spinning frequency, and leg-ground. As an example, a controller such as, for example, a VSD controller may implement control based in part on signals received via one or more ESP coupled sensor units.

In the example of FIG. 5, the ESP motor controller 550 includes various modules to handle, for example, backspin of an ESP, sanding of an ESP, flux of an ESP and gas lock of an ESP. The motor controller 550 may include any of a variety of features, additionally, alternatively, etc.

In the example of FIG. 5, the VSD unit 570 may be a low voltage drive (LVD) unit, a medium voltage drive (MVD) unit or other type of unit (e.g., a high voltage drive, which may provide a voltage in excess of about 4.16 kV). As an example, the VSD unit 570 may receive power with a voltage of about 4.16 kV and control a motor as a load with a voltage from about 0 V to about 4.16 kV. The VSD unit 570 may include commercially available control circuitry such as the SPEEDSTAR™ MVD control circuitry marketed by Schlumberger Limited (Houston, Tex.).

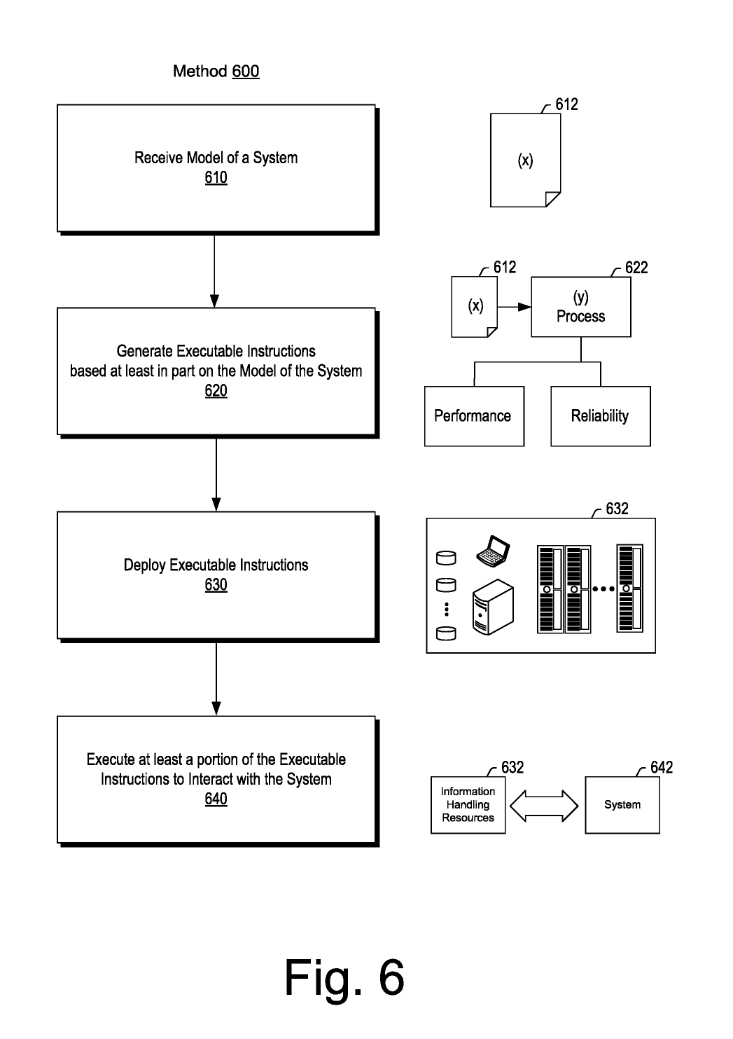

FIG. 6 shows an example of a method 600 that includes a reception block 610 for receiving a model of a field equipment system expressed in a domain specific language, a generation block 620 for generating executable instructions based at least in part on the model of the system as expressed in the domain specific language, a deployment block 630 for deploying the executable instructions and an execution block 640 for executing at least a portion of the executable instructions to interact with the system.

FIG. 6 also shows an example of a file 612 that includes a representation of the system, for example, as a model expressed at least in part in a domain specific language; and a process 622 that can process information in the file 612 to generate executable instructions, optionally directed to one or more aspects such as performance, reliability, etc. As shown in FIG. 6, information handling resources 632 such as computing equipment, network equipment, storage equipment, etc., may be utilized in executing at least a portion of executable instructions where, upon execution, the information handling resources 632 may interact with the modeled system.

As an example, a method can include a developer creating a model of an acquisition system; and a code generator generating software to establish a protocol and a strategy for handling communication between equipment and the acquisition system. In such an example, generated code may be packaged using one or more defined strategies. For example, consider a high performance focused strategy, a high reliability focused strategy, etc. As an example, a method can include deploying generated code, for example, as a part of acquisition system code.

As an example, a high performance strategy and/or a high reliability strategy may provide code that can perform tasks as to one or more of data acquisition, control, storage, computation, visualization, and communication.

As an example, in FIG. 6, “(x)” can represent a model created by a user based on a domain specific language (DSL), domain expert or another system. Such a model can describe the way different systems communicate, store, display and/or deliver information, for example, by using a grammar for describing the content of messages exchanges. As an example, in FIG. 6, “(y)” can represent a process by which the model (x) is transformed into software source code, applying different strategies to create source code with different quality attributes such as performance focused, reliability focused, etc. As an example, in FIG. 6, an acquisition system can integrate the generated code for use during operations where such code may provide for communication between different equipment, store, display and/or deliver data. As an example, data storage, visualization and/or deliverable generation may be described by the model (x) and generated by the process (y). As an example, equipment communicating with one or more acquisition systems may be integrated in a relatively seamless manner.

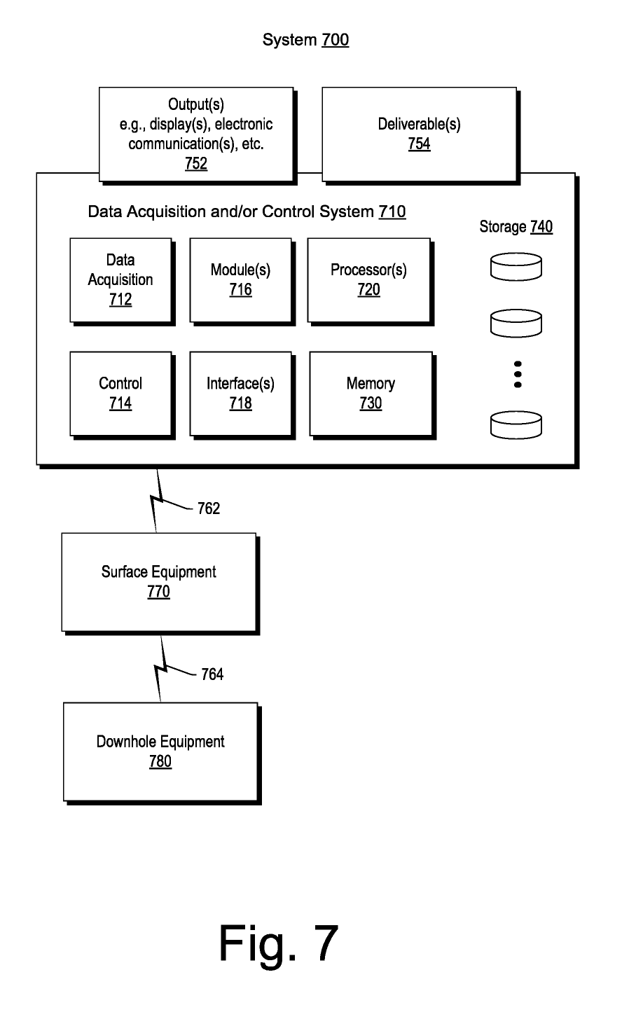

FIG. 7 shows an example of a system 700 that includes a data acquisition and/or control system 710, which is operatively coupled to surface equipment 770 and/or operatively coupled to downhole equipment 780, for example, directly and/or indirectly via the surface equipment 770. For example, one or more communication channels 762 and 764 may be present in the system 700. As an example, a communication channel may provide for uni-directional and/or bi-directional transfer of information (e.g., commands, data, etc.). As an example, a communication channel may include equipment for wired and/or wireless transmission of information.

As shown in the example of FIG. 7, the data acquisition and/or control system 710 includes data acquisition equipment 712, control equipment 714, one or more modules 716, one or more interfaces 718, one or more processors 720, memory 730 accessible by at least one processor, and storage 740. The system 710 can provide for one or more outputs 752 and/or one or more deliverables 754. As an example, the one or more modules 716 can include executable code generated by compilation of a domain specific language that expresses a model of the system 700.

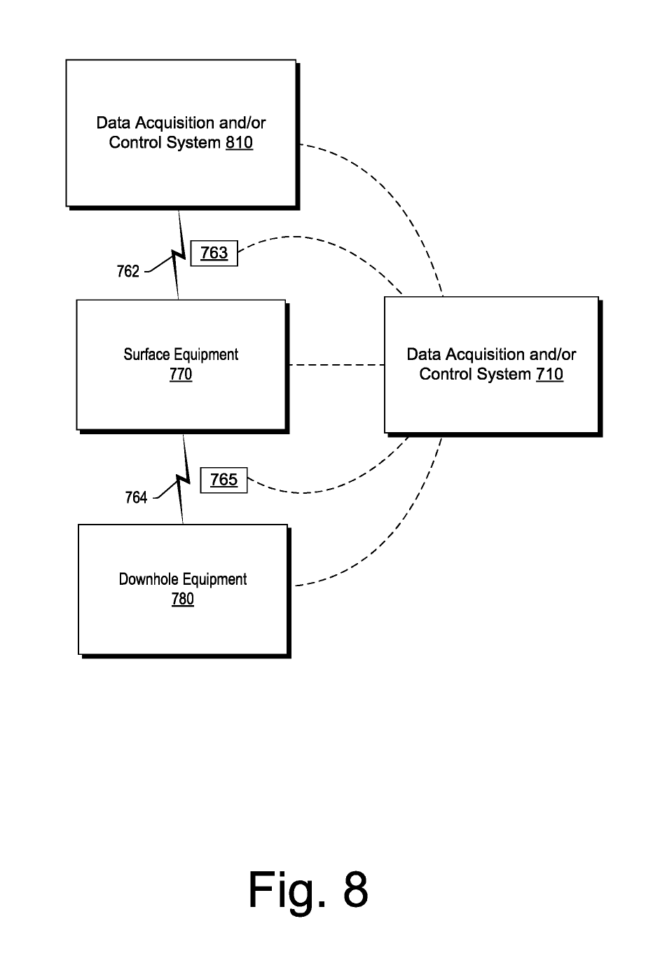

FIG. 8 shows an example of an arrangement where the data acquisition and/or control system 710 of FIG. 7 can interface with a data acquisition and/or control system 810, the communication channel 762 via a junction or tap 763 and/or the communication channel 764 via a junction or tap 765.

As an example, a junction or tap may be or include router equipment, which may provide for wired and/or wireless transmission. As an example, a system may include one or more I²C (Inter-Integrated Circuit) busses. As an example, a system may include one or more Serial Data Lines (SDAs) and one or more Serial Clock Lines (SCLs). As an example, a system may include one or more multi-master, multi-slave, single-ended, serial computer busses. As an example, a bus may provide for transmission of information to one or more devices that may include a processor, a microcontroller (e.g., ARM, RISC, etc.). As an example, a system may include one or more SMBuses, which may include or be subset type of I²C (e.g., that defines the protocols more strictly).

As an example, a specification may define types of messages that can be transmitted via a bus or busses. As an example, consider a message that commences with a START command and that ends with a STOP command. As an example, consider a single message where a master writes data to a slave, a single message where a master reads data from a slave, and/or combined messages, where a master issues at least two reads and/or writes to one or more slaves. As an example, a read or write may begin with a START command and a slave address.

As an example, a domain specific language may include expressions for transmission of information via one or more types of busses. As an example, a domain specific language may include expressions for addressing a piece of equipment accessible via a bus, optionally via wired and/or wireless transmission of signals. As an example, a term such as “ESP” may be provided in a domain specific language where compilation of the domain specific language associates the term “ESP” with an address of a bus, a network, etc.

As an example, a DSL may express equipment, logic, actions, etc., associated with equipment, which can include data acquisition equipment. As an example, equipment can include one or more types of oilfield related equipment that emits data. As an example, a model may be an instance of a DSL. As an example, an instance may provide for control of acquisition equipment, which may be one or more types of oilfield related acquisition equipment that emit data. As an example, a piece of equipment may be fit with circuitry such as, for example, a sensor, a receiver, a transmitter, a transceiver, an interface, etc. As an example, a piece of equipment may be fit with a radio frequency identification circuit such as, for example, an RFID reader and/or transmitter. In such an example, identity of the equipment may be ascertained and/or location of the equipment may be ascertained via a data acquisition system. Such information may be germane to a workflow, optionally including, for example, one or more of safety aspects of a workflow, regulatory aspects of a workflow, inventory aspects of a workflow, etc.

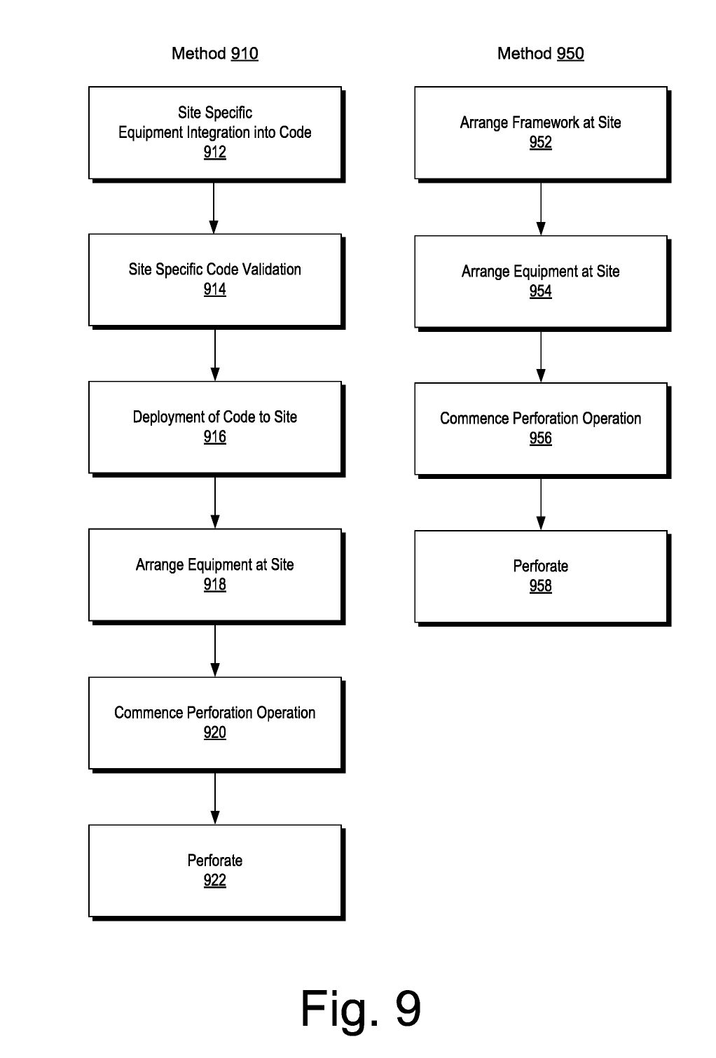

FIG. 9 shows an example of a method 910 associated with a perforation operation and an example of a method 950 associated with a perforation operation. The method 910 includes a site specific equipment integration block 912 for equipment integration into code, a site specific code validation block 914 for validation of code, a deployment block 916 for deployment of code to a site, an arrangement block 918 for arranging equipment at the site, a commencement block 920 for commencing perforation operations and a perforation block 922 for perforating, for example, by detonating charges of a perforation gun.

In the example of FIG. 9, the method 950 includes an arrangement block 952 for arranging a framework at a site, an arrangement block 954 for arranging equipment at the site, a commencement block 956 for commencing a perforation operation and a perforation block 958 for perforating, for example, by detonating charges of a perforation gun.

Tables 1 and 2 below provide information as to examples of methods where, for example, the approach of Table 1 may correspond to the method 910 of FIG. 9 and where the approach of Table 2 may correspond to the method 950 of FIG. 9.

TABLE 1

| | |
|---|---|
| Equipment | For up to a year or more, equipment representation is |
| integrated | modeled in the acquisition software that will be |
| in software | deployed and used in the field. The development of |
| | such software may be error prone that may possibly |
| | engender risks while operating the equipment. |
| | Various types of perforating equipment are to be |
| | operated with special care (e.g., following |
| | process/regulations while the software is developed). |
| Equipment | Validation includes spending time during a |
| software | development process of software to ensure the |
| validation | software is acting appropriately in a best case |
| | scenario as well as in negative testing. Various tests |
| | can include human driven tests however sometimes |
| | without real equipment, which can make testing of |
| | each piece of software challenging. |
| Software | Users assemble physical hardware and equipment. |
| deployed | |
| to the wellsite/rig | |
| Equipment rig up | Users configure software to manage |
| on site | equipment/perforating guns |
| Perforation | Users follow the safety guidelines per standard work |
| Operation begins | instructions to guide them during the intervention |
| | operation. |
| Perforation | When arriving at the proper depth software allows a |
| execution | user to press a detonation trigger, executing sub |
| | surface perforations to connect a borehole to a |
| | reservoir. This trigger involves manually coded |
| | software execution as expected by a software |
| | developer. Quality issues with the software and the |
| | validation cycle can be impacted by variations of the |
| | perforation design and configurations. |

TABLE 2

| | |
|---|---|
| Software | Users assemble physical hardware and equipment. |
| deployed to | |
| the wellsite/ | |
| rig | |
| Equipment | Users configure software to manage equipment/perforating |
| rig up on | guns. For example, by assembling building blocks for a |
| site | perforation process. The safety measures are enabled and |
| | enforced by selection of the equipment by the user |
| | designing the desired process. |
| Perforation | Users follow the safety guidelines per standard work |
| Operation | instructions to guide them during the intervention operation. |
| begins | |
| Perforation | When arriving at the proper depth software allows a user to |
| execution | actuate a detonation trigger, executing the sub surface |
| | perforation to connect a borehole to a reservoir. The trigger |
| | is implemented via a consistent safety protocol enforced by |
| | using a model expressed in DSL to establish that pre- |
| | requisites are validated and that no software issue could |
| | cause damage to personnel or equipment. A level of con- |
| | sistency resulting from building a systematic perforation |
| | process via a DSL-based model for various sites, equip- |
| | ment, etc., can help to ensure operational safety and |
| | integrity during performance of a job. |

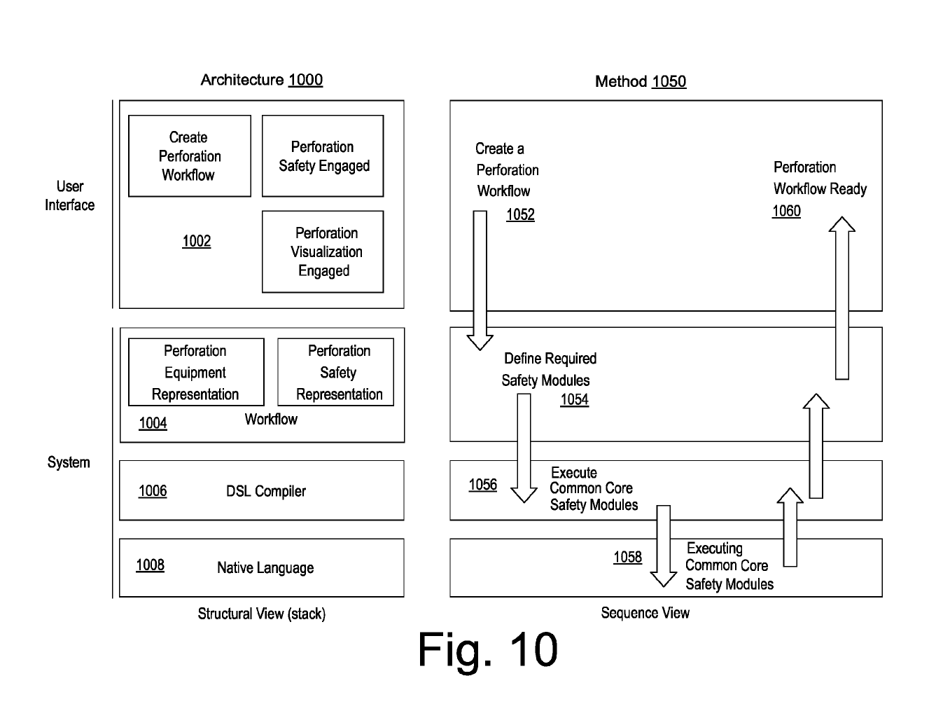

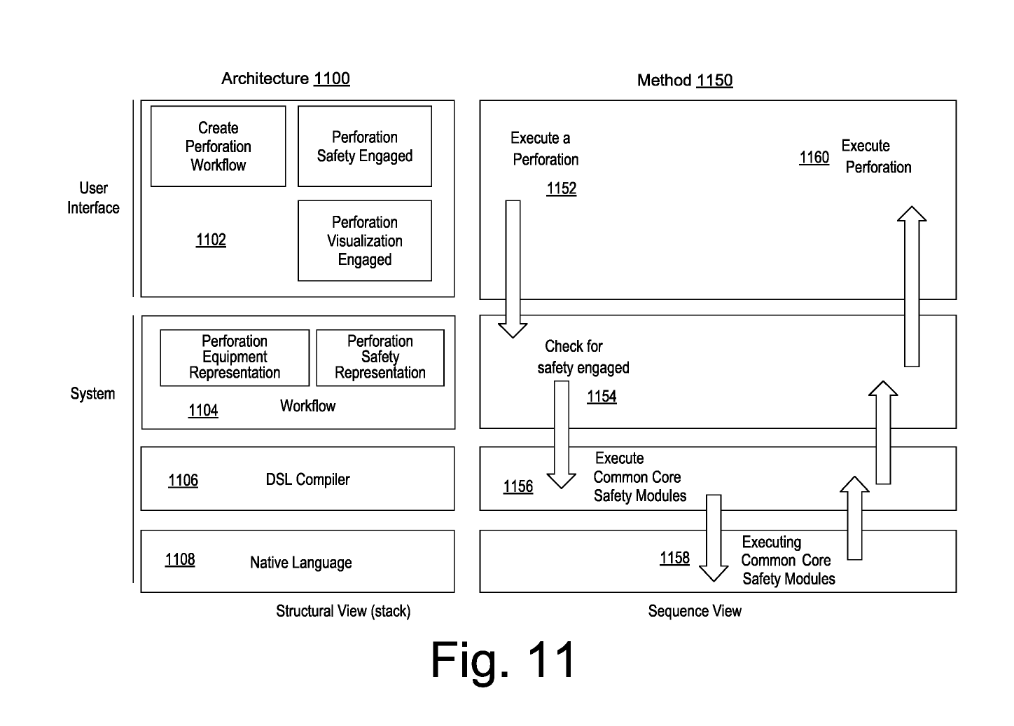

FIGS. 10 and 11 show examples of architectures 1000 and 1100 and examples of methods 1050 and 1150. These examples may correspond in part, for example, to a process such as that outlined in Table 2.

In the examples of FIGS. 10 and 11, the architectures 1000 and 1100 include a user interface portion 1002, 1102 and a system portion with components 1004, 1104, 1006, 1106, 1008, 1108. For example, a user interface portion may be part of a framework that includes structures expressed in domain specific manner for creation of a perforation workflow. In such an example, structures may provide for safety and visualization. For example, safety may be assured via an actuatable control option. As mentioned, such an option may be operatively coupled to a verification process that verifies validation of a model expressed in a domain specific language (e.g., via an expert, etc.).

As to the system portion, in the examples of FIGS. 10 and 11, it may include workflow information corresponding to representations as created via the user interface, a domain specific language compiler and a native language storage for storing one or more native languages that may be native to equipment (e.g., assembly language, object-oriented programming language, etc.). As an example, a native language may be an interpreted language and/or a compilable language. As an example, a native language may be an object-oriented language that can be compiled to form executable instructions, which may be, for example, in a binary format (e.g., binary code).

As an example, a system may employ a Common Intermediate Language, for example, as a lowest-level human-readable programming language defined by a Common Language Infrastructure (CLI) specification (e.g., as in the .NET framework, etc.). Languages that target a CLI-compatible runtime environment compile to CIL, which is assembled into an object code that has a bytecode-style format. CIL is an object-oriented assembly language, and is stack-based. Its bytecode is translated into native code or, for example, executed by a virtual machine.

As an example, a system may employ a language such as, for example, C#. C# is a multi-paradigm programming language encompassing strong typing, imperative, declarative, functional, generic, object-oriented (e.g., class-based), and component-oriented programming approaches. C# is one of a plurality of programming languages designed for the Common Language Infrastructure (CLI).

As an example, a system may employ a language such as, for example, C. The C language is a general-purpose, imperative computer programming language, supporting structured programming, lexical variable scope and recursion, while a static type system may prevent various unintended operations. C provides constructs that map to typical machine instructions, and may find use in applications such as those that can be coded in assembly language, including operating systems, as well as various application software for computers ranging from supercomputers to embedded systems.

As shown in the example of FIG. 10, the method 1050 includes a creation block 1052 for creating a workflow such as, for example, a perforation workflow at the level of the user interface level 1002 of the architecture 1000, a definition block 1054 for defining desired safety modules (e.g., according to job specifications and/or regulatory specifications) at the level of the workflow component 1004 of the system of the architecture 1000, an execute block 1056 for executing (e.g., compiling) a core and safety modules at the level of the domain specific language (DSL) complier component 1006 of the system of the architecture 1000, and an execution block 1058 for executing core and safety modules at the level of the native language component 1008 of the system of the architecture 1000, which can include generating native language instructions that can be executed to perform at least a portion of the workflow. As shown in FIG. 10, the method 1050 can include feedback from the various levels of the architecture 1000 such that the user interface 1002 can render information to a display (e.g., as a graphical user interface) that can inform a user that the various levels of the system of the architecture 1000 have performed tasks sufficient to generate executable instructions (e.g., in a selected native language or native languages) to provide for performing the workflow, which, as shown, may be a perforation workflow.

As shown in the example of FIG. 11, the method 1150 includes an execute block 1152 for executing a workflow such as, for example, a perforation workflow at the level of the user interface level 1102 of the architecture 1100, a check block 1154 for checking safety measures (e.g., according to job specifications and/or regulatory specifications) at the level of the workflow component 1104 of the system of the architecture 1100, an execute block 1156 for executing (e.g., compiling) a core and safety modules at the level of the domain specific language (DSL) complier component 1106 of the system of the architecture 1100, and an execution block 1158 for executing core and safety modules at the level of the native language component 1108 of the system of the architecture 1100, which can include generating native language instructions that can be executed to perform at least a portion of the workflow and/or transmitting native language instructions that can be executed to perform at least a portion of the workflow. As shown in FIG. 11, the method 1150 can include feedback from the various levels of the architecture 1100 such that the user interface 1102 can render information to a display (e.g., as a graphical user interface) that can inform a user that the various levels of the system of the architecture 1100 have performed tasks sufficient to generate executable instructions (e.g., in a selected native language or native languages) and/or to transmit executable instructions to provide for performing the workflow, which, as shown, may be a perforation workflow.

As an example, one or more workflows may be created off-site and then executed on-site. As an example, a workflow database may be accessed that includes various workflows that can be utilized, modified, etc. As an example, an application may receive information via a network or networks at a field equipment site that informs the application as to what equipment and/or what conditions exist at that field equipment site. Such information may be utilized to tailor a workflow for a particular field equipment site.

As an example, the architecture 1000 and/or the architecture 1100 can output instructions (e.g., transmit instructions) that can be utilized to perform at least a portion of a workflow as generated via interactions with a user interface. As an example, such a user interface may be in the form of an application, which may optionally be a browser application that interacts as a client in a client-server system.

As an example, an application may be an “app” that is executable at least in part via a mobile device such as, for example, a cellular phone, cellular tablet, etc., that includes a base operating system (e.g., iOS™, ANDROID™ WINDOWS™, etc.). As an example, an application may be executed at least in part on a device that includes a touch screen such that touch input can provide for selection of items to create a workflow. As an example, such an application may render graphical representations of equipment and optionally actions of such equipment along with a time line or a logical flow, which may include “IF-THEN” statements, time limits, safety checks, etc. As an example, a device may be operatively coupled to a network at a field equipment site where equipment at the field equipment site is operatively coupled to the network, which can be a secure network (e.g., via keys, credentials, trusted platform module (TPM) technology, etc.). As an example, a device may transmit instructions to the network (e.g., or networks) via one or more network interfaces such that equipment operates at least in part based on such instructions. As an example, an instruction may be associated with a perforation operation, which is to occur within a scope of one or more regulatory frameworks.

As an example, an application can include performing a method that includes generating one or more reports and/or transmitting one or more reports. For example, where a regulatory entity demands documentation of certain types of operations at a field equipment site (e.g., explosive operations, etc.), the application can generate a report as part of a workflow, which may be defined selectively or automatically depending on the type of operations in a workflow. In such an example, the application can receive feedback from one or more operations executed at a field equipment site, which may confirm that the workflow operations have been executed in a desired manner or not.

As an example, a graphical user interface rendered to a display of a device can include a time line with operations to be performed where feedback is received as the operations are performed such that a user may monitor the performance of the workflow, optionally with an ability to intervene via the GUI rendered to the display. For example, a “stop” button may be rendered to the GUI where a user may actuate the stop button to halt the workflow. For example, where the display is a touch screen display, a user may touch the touch screen display such that an application receives an instruction to halt the workflow being performed.

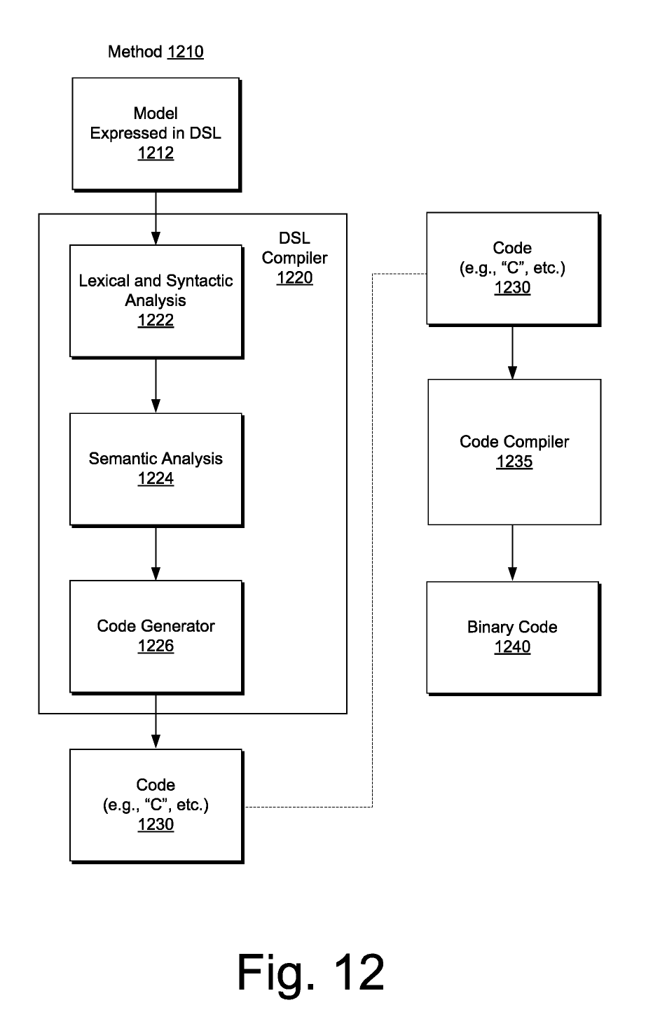

FIG. 12 shows an example of a method 1210 that includes a reception block 1212 for receiving a model expressed in DSL, a DSL compiler block 1220 for compiling DSL to code and an output block 1230 for outputting compiled code. As shown, the output block 1230 may output code to a code compiler block 1235 for compiling the code to binary code (e.g., or other executable code, etc.) and an output block 1240 for outputting the compiled binary code (e.g., or other executable code, etc.).

As shown in the example of FIG. 12, the method 1210 can include a lexical and syntactic analysis block 1222, a semantic analysis block 1224 and a code generator block 1226, which may be components of the DSL compiler 1220.

As an example, the DSL compiler 1220 may be equipment aware in that equipment at a field equipment site may operate via instructions in different types of code. As an example, a field equipment site may include a control system that operates via a particular type of code and that generates equipment specific code. For example, one piece of equipment may operate according to one type of code and another piece of equipment may operate according to another type of code. As an example, the DSL compiler 1220 and/or a site control system may generate code specific to equipment with knowledge of those equipment code specifics.

As an example, where a code incompatibility exists, an application may render information to a display to inform a user that a particular type of code is not within capabilities of the application; noting that where an update, add-on, etc., is available, the application may render information that allows for installation and use of the update, add-on, etc. to provide for code compatibility. In such an example, the application may be equipment aware. As an example, an application may include a feature that snoops for networks and equipment operatively coupled to one or more networks (e.g., via WiFi™, BLUETOOTH™, cellular, etc.).

As mentioned, a method may include interpretation such as, for example, via an interpreter. As an example, an interpreter can be a computer program that executes instructions written in a programming or scripting language, for example, without previously compiling them into a machine language program. As an example, an interpreter may implement one or more of the following strategies for program execution: parse the source code and perform its behavior directly; translate source code into some efficient intermediate representation and immediately execute this; and explicitly execute stored precompiled code made by a compiler which is part of an interpreter system. As an example, an interpreter may analyze individual statements in a program as it is executed and then perform an indicated action.

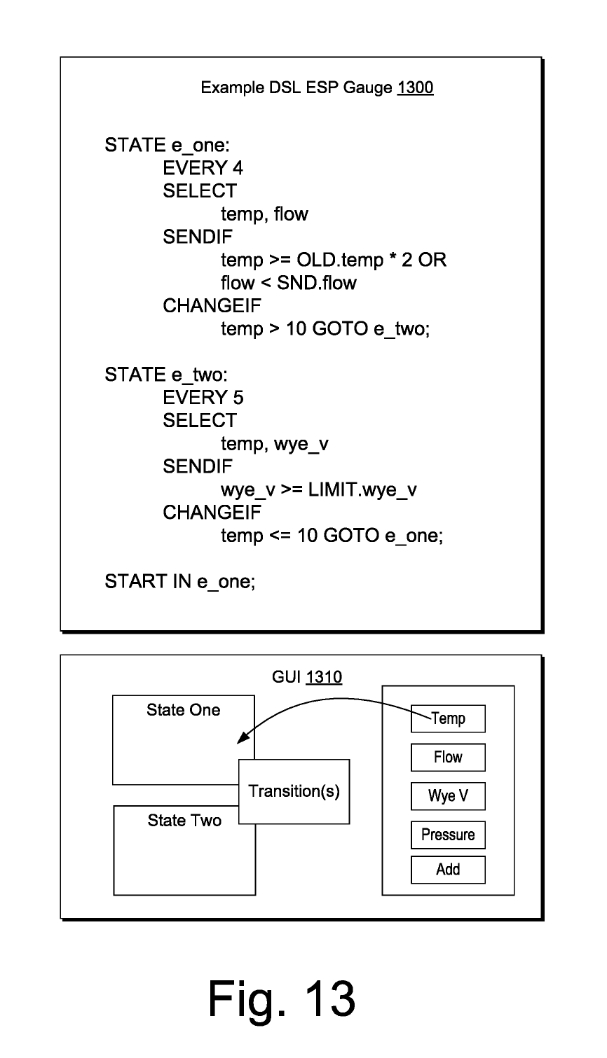

FIG. 13 shows an example of DSL 1300 that expresses actions with respect to information of an ESP gauge and also shows an example of a graphical user interface (GUI) 1310. In the example of FIG. 13, the DSL 1300 specifies two states, state one and state two. The information acquired from the ESP gauge includes temperature, flow rate and wye point voltage of a multiphase electric motor of the ESP; noting that the gauge may be operatively coupled to the wye point and derive power from the wye point (e.g., as carried by one or more conductors of a multiphase power cable).

In the example of FIG. 13, terms include “STATE”, “EVERY”, “SENDIF”, “CHANGEIF”. Such terms may be understood by an operator to build logic for purposes of data acquisition, data communication, control, etc. As shown, the states are defined by the domain specific language with respect to sensed values, reading frequency (e.g., at intervals of about 4 seconds, 5 seconds, etc.) and logic. As an example, a value or other condition may trigger reading of one or more sensors. For example, consider the wye point voltage (e.g., indicative of an amount of unbalance, etc.) being read in response to a condition associated with another measured value or values. The example DSL 1300 provides for a state transition from state one to state two and back depending at least in part on values of data acquired by a gauge. Such DSL may optionally be created via a graphical user interface (GUI) such as, for example, the GUI 1310. Such a GUI may include drag and drop functionality. For example, states may be created and one or more measurements (e.g., of a data acquisition system, etc.) may be dragged and dropped on to states to define the states as being dependent at least in part on such one or more measurements. As an example, where more than one state is expressed for a system, the GUI 1310 may include a transition control that allows for specifying one or more conditions that allow for transitioning from one state to another state (e.g., state transition logic, etc.).

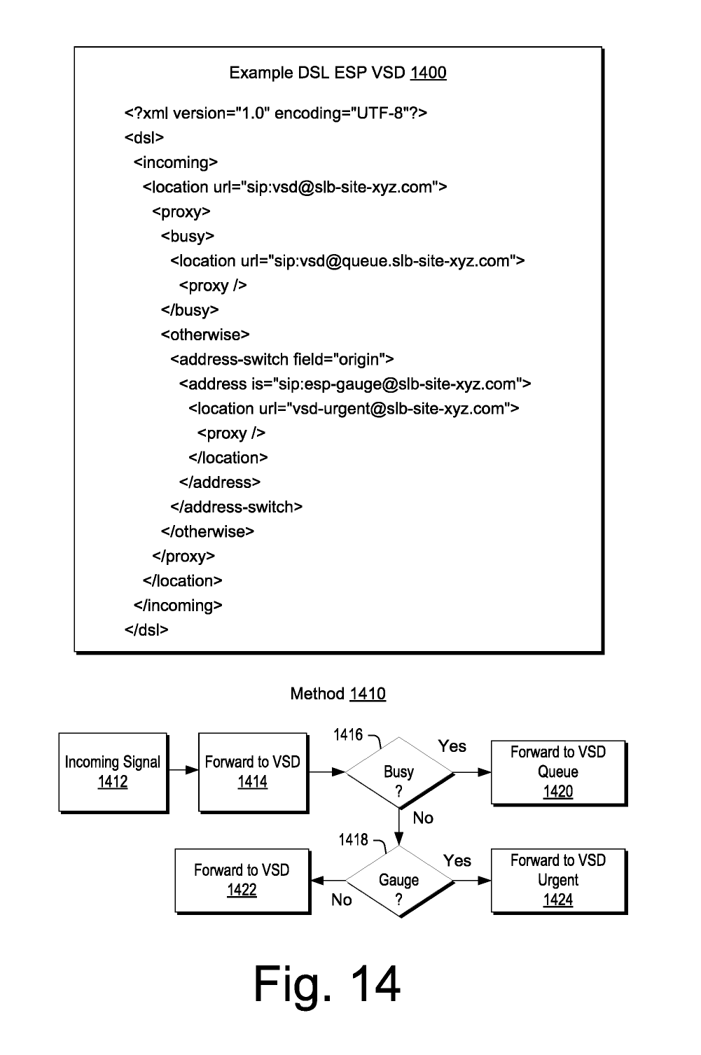

FIG. 14 shows an example of DSL 1400 expressed for a model that includes an ESP and a VSD that can control the ESP as well as a method 1410, which may be a flow chart graphic that may optionally be generated before, during and/or after setting up the DSL 1400. As an example, an application such as a flow chart application may be utilized to construct DSL. For example, consider a VISIO™ application GUI where a flow chart may be created and where words may be entered into blocks where the words correspond to DSL terms. In such an example, the terms may be handled by a DSL compiler and the blocks, as arranged, may be handled by a DSL complier as to one or more of logic, communication, etc. As mentioned, a DSL term for a piece of equipment may be associated with an address, which may be, for example, a bus address, a network address, etc. As an example, a DSL framework may generate addresses based on terms such as a site term and an equipment term. For example, for a site “xyz” and a piece of equipment “perforating gun”, may be formulated into an address such as, for example, “perforating-gun@site-xyz.com”.

In the example of FIG. 14, the method 1410 includes a reception block 1412 for receiving an incoming signal (e.g., in a data acquisition system, etc.), a forward block 1414 for forwarding the signal to a VSD, a decision block 1416 for deciding whether the VSD is busy (e.g., VSD interface, etc.), a decision block 1418 for deciding whether the incoming signal is from a gauge of an ESP controlled by the VSD, a forward block 1420 for forwarding the signal to a queue, a forward block 1422 for forwarding the signal to the VSD and a forward block 1424 for forwarding the signal to the VSD with a priority indication (e.g., “urgent”), which may cause the VSD to expeditiously receive and process the signal.

As shown with respect to the DSL 1400, it may include mark-up language such as XML and addresses may be specified as in an email system, where a domain name may be utilized. For an individual that has experience reading XML, such an approach may allow for review and validation. Further, for an individual that has experience with email, such an approach may allow for review and validation. For example, as mentioned, an email type of address may include a name of a piece of equipment and optionally a site indicator. As an example, a piece of equipment may include a high priority “inbox” (e.g., interface, memory, etc.) such as “vsd-urgent”. In the example of FIG. 14, a person may review to determine that information may be coming from a gauge of an ESP (e.g., “esp-gauge”) at a site (e.g., “slb-site-xyz”). Validation may be facilitated by examining the equipment portion (e.g., akin to user name) and the site portion of an address (e.g., “domain name” portion, etc.).

The example DSL 1400 of FIG. 14 demonstrates how communications may be handled via expressions in a DSL for a model of a field equipment system. The approach of FIG. 14 may be amenable to relatively rapid review, particularly for individuals acquainted with XML and email system (e.g., OUTLOOK™ email system, etc.).

As an example, DSL may include terms for building a communication model, optionally with one or more protocols. For example, where information is transmitted via a network, DSL may include terms to specify network names, network addresses, network equipment, network physical locations, network virtual locations, network protocols, network payloads, network headers, etc.

As an example, as to regulatory issues (e.g., compliance, etc.), a method can include transmitting information as to location, state, etc., of one or more pieces of equipment, components, etc. For example, a perforating gun may be regulated according to the U.S. Bureau of Alcohol, Tobacco, Firearms and Explosive (ATF). As an example, consider ATF Rul. 2010-7, which is incorporated by reference herein and states, in part: “ATF authorizes an alternate method or procedure from the provisions of 27 CFR 555.205 requiring the storage of explosive devices inside a locked magazine. Specifically, ATF authorizes explosives licensees and permittees to store loaded perforating guns outside of a locked magazine provided all of the requirements stated in this ruling are met.” As an example, where a loaded perforating gun is moved from one location to another, a data acquisition or other system may track and/or receive information as to its location. In such an example, a message may be communicated to a regulatory authority and/or to a regulatory log. As stated in ATF Rul. 2010-7: “A daily summary of magazine transactions (27 CFR 555.127) must be maintained for each area, building, or vehicle that contains loaded perforating guns. Quantity entries may be expressed as the number of individual perforating guns stored within each separate area, building, or vehicle.”

As an example, a domain specific language may include a regulatory module that includes terms such as “regulatory log” that allow for a model of a field equipment system to transmit information to an address associated with such a log. As an example, during performance of a workflow, flags may exist within a model (e.g., as set by a user when building a DSL graphic, file, etc.) that call for transmission of information to a regulatory log. Such a log may be a “daily summary of magazine transactions” and may include information for a site or sites (e.g., area, building, vehicle, etc.). As an example, such a log may be a deliverable that is formatted or formatable for purposes of meeting rules, regulations, etc., of one or more regulatory agencies. As an example, a DSL may provide for linking safety and regulations. For example, consider one or more of the actions described with respect to FIGS. 10 and 11 as associated with safety as optionally being associated with one or more regulations. In such examples, information may be logged and, as appropriate, delivered to an authority for review, compliance, etc.

As an example, a framework such as, for example, the VISUAL STUDIO™ framework (Microsoft Corporation, Redmond, Wash.), may be utilized to perform one or more DSL related tasks (e.g., consider one or more DSL tools, etc.). As an example, a so-called “ModelBus” of the VISUAL STUDIO™ framework can provide for creating links between models (e.g., instances of DSL) and from other tools into models. For example, a method can include linking one or more DSL models and/or UML models. As an example, a DSL framework may include sub-DSLs where a framework such as, for example, the VISUAL STUDIO™ framework, can facilitate creation of an integrated set of DSLs. As an example, a framework such as, for example, the VISUAL STUDIO™ framework, may be utilized to build one or more domain specific languages.

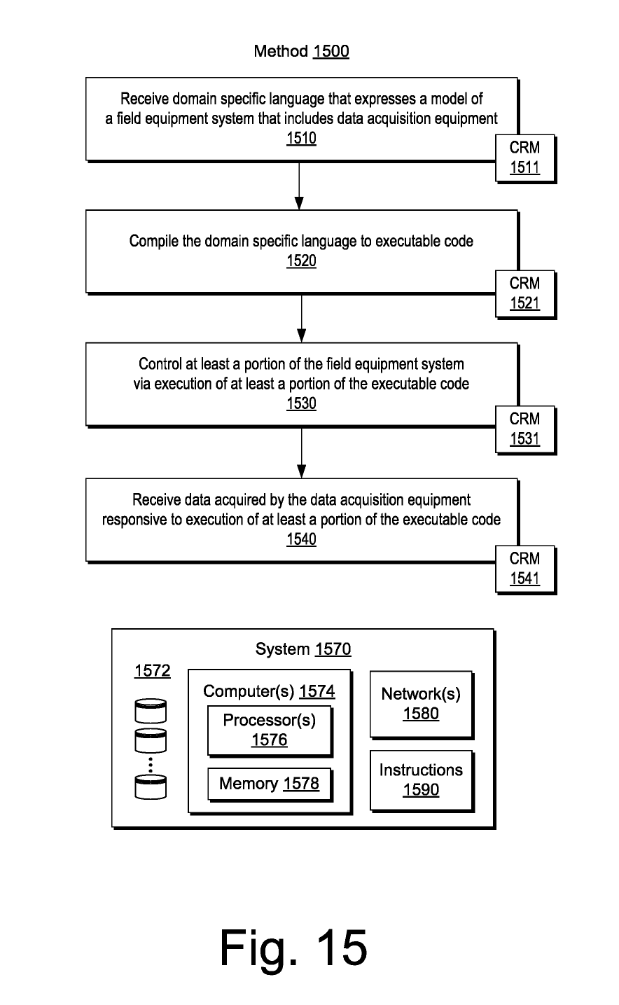

FIG. 15 shows an example of a method 1500 and an example of a system 1570. As shown, the method 1500 includes a reception block 1510 for receiving domain specific language that expresses a model of a field equipment system that includes data acquisition equipment; a compilation block 1520 for compiling the domain specific language to executable code (e.g., or interpreting the domain specific language to executable code); a control block 1530 for controlling at least a portion of the field equipment system (e.g., one or more pieces of equipment) by executing at least a portion of the executable code; and a reception block 1540 for receiving data acquired by the data acquisition equipment responsive to executing at least a portion of the executable code.

The method 1500 is shown in FIG. 15 in association with various computer-readable media (CRM) blocks 1511, 1521, 1531 and 1541. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1500. As an example, a computer-readable medium (CRM) may be a computer-readable storage medium that is non-transitory and not a carrier wave.

In the example of FIG. 15, the system 1570 includes one or more information storage devices 1572, one or more computers 1574, one or more networks 1580 and instructions 1590. As to the one or more computers 1574, each computer may include one or more processors (e.g., or processing cores) 1576 and memory 1578 for storing the instructions 1590 (e.g., modules), for example, executable by at least one of the one or more processors. As an example, a computer may include one or more network interfaces (e.g., wired or wireless), one or more graphics cards, a display interface (e.g., wired or wireless), etc.

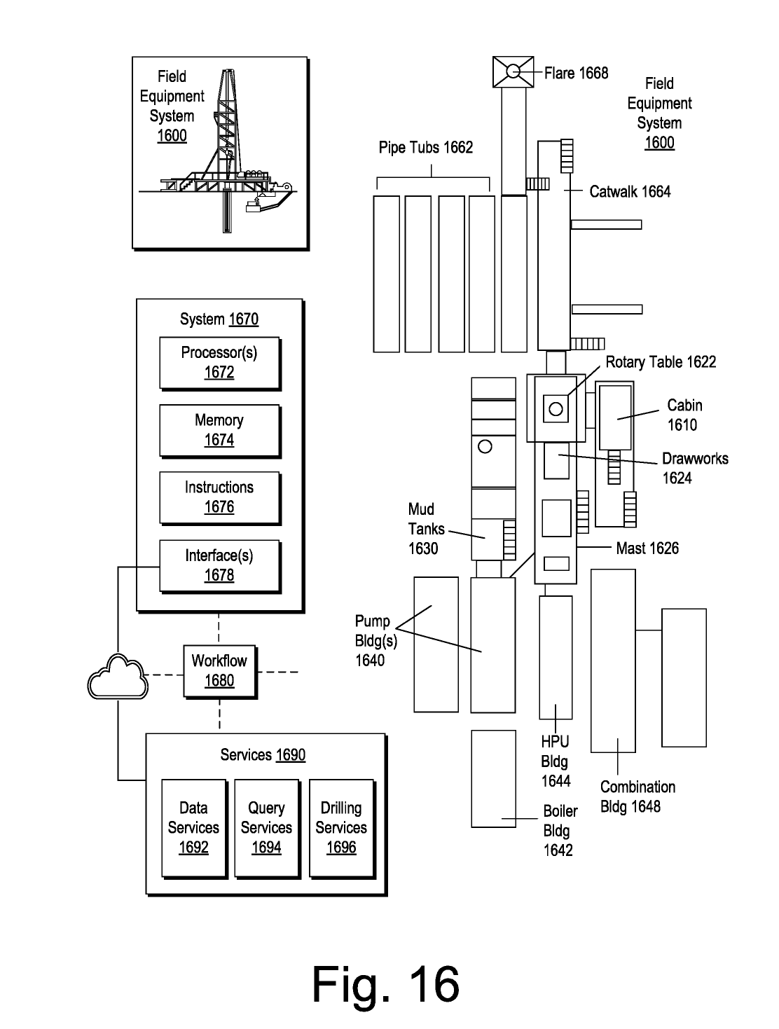

FIG. 16 shows an example of a field equipment system 1600, specifically, FIG. 16 shows the field equipment system 1600 in an approximate side view and an approximate plan view along with a block diagram of a system 1670.

In the example of FIG. 16, the field equipment system 1600 can include a cabin 1610, a rotary table 1622, drawworks 1624, a mast 1626 (e.g., optionally carrying a top drive, etc.), mud tanks 1630 (e.g., with one or more pumps, one or more shakers, etc.), one or more pump buildings 1640, a boiler building 1642, an HPU building 1644 (e.g., with a rig fuel tank, etc.), a combination building 1648 (e.g., with one or more generators, etc.), pipe tubs 1662, a catwalk 1664, a flare 1668, etc. Such equipment can include one or more associated functions and/or one or more associated operational risks, which may be risks as to time, resources, and/or humans.

As shown in the example of FIG. 16, the field equipment system 1600 can include a computing system 1670 that includes one or more processors 1672, memory 1674 operatively coupled to at least one of the one or more processors 1672, instructions 1676 that can be, for example, stored in the memory 1674, and one or more interfaces 1678. As an example, the system 1670 can include one or more processor-readable media that include processor-executable instructions executable by at least one of the one or more processors 1672 to cause the system 1670 to control one or more aspects of the field equipment system 1600. In such an example, the memory 1674 can be or include the one or more processor-readable media where the processor-executable instructions can be or include instructions. As an example, a processor-readable medium can be a computer-readable storage medium that is not a signal and that is not a carrier wave.

As an example, the one or more interfaces 1678 can be operatively coupled to network equipment of the field equipment system 1600. As an example, such network equipment can include equipment for wired and/or wireless communications. Various pieces of equipment at the field equipment site 1600 can be network enabled and may include one or more network interfaces such that the computing system 1670 can transmit information to and/or receive information from such pieces of equipment, directly and/or indirectly.

FIG. 16 also shows a workflow component 1680 that may be operatively coupled to the system 1670. As an example, the workflow component 1680 may be part of an on-site system and/or a remote, off-site system. As an example, the workflow component 1680 may be operatively coupled to a network, which may be a cloud network. As an example, the workflow component 1680 may be operatively coupled to one or more pieces of equipment via wired and/or wireless technology. As an example, the workflow component 1680 may be part of a system such as a system that includes one or more features of the architectures 1000 and 1100.

In the example of FIG. 16, services 1690 are shown as being available, for example, via a cloud platform. Such services can include data services 1692, query services 1094 and drilling services 1096. As an example, the services 1690 may be part of a system such as a system that includes one or more features of the architectures 1000 and 1100.

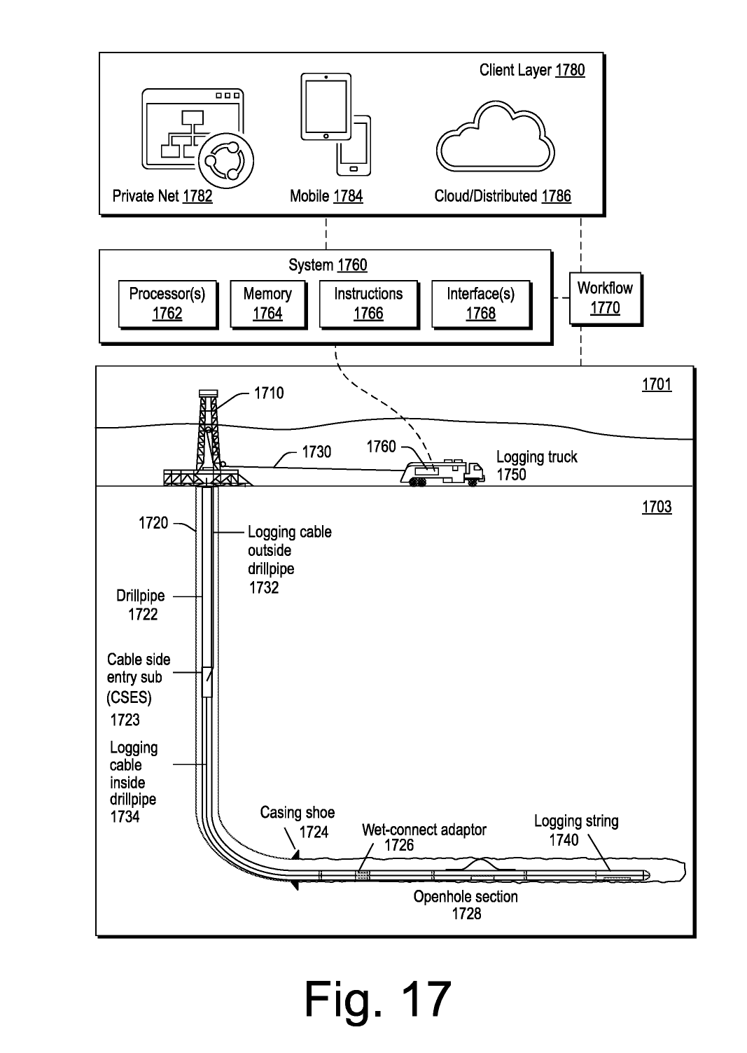

FIG. 17 shows an example of an environment 1701 that includes a subterranean portion 1703 where a structure 1710 (e.g., a rig or other structure) is positioned at a surface location above a bore 1720. In the example of FIG. 17, various wirelines services equipment (e.g., field equipment) can be operated to perform one or more wirelines services including, for example, acquisition of data from one or more positions within the bore 1720. The subterranean portion 1703 can include hydrocarbons as in a hydrocarbon field (e.g., oil field, gas field, oil and gas field).

In the example of FIG. 17, the bore 1720 includes drillpipe 1722, a casing shoe, a cable side entry sub (CSES) 1723, a wet-connector adaptor 1726 and an openhole section 1728. As an example, the bore 1720 can be a vertical bore or a deviated bore where one or more portions of the bore may be vertical and one or more portions of the bore may be deviated, including substantially horizontal.

In the example of FIG. 17, the CSES 1723 can include a cable clamp, a packoff seal assembly and a check valve. These components can provide for insertion of a logging cable 1730 that includes a portion 1732 that runs outside the drillpipe 1722 to be inserted into the drillpipe 1722 such that at least a portion 1734 of the logging cable runs inside the drillpipe 1722. In the example of FIG. 17, the logging cable 1730 runs past the wet-connect adaptor 1726 and into the openhole section 1728 to a logging string 1740.

As shown in the example of FIG. 17, a logging truck 1750 (e.g., a wirelines services vehicle) can deploy the wireline 1730 under control of a system 1760. As shown in the example of FIG. 17, the system 1760 can include one or more processors 1762, memory 1764 operatively coupled to at least one of the one or more processors 1762, instructions 1766 that can be, for example, stored in the memory 1764, and one or more interfaces 1768. As an example, the system 1760 can include one or more processor-readable media that include processor-executable instructions executable by at least one of the one or more processors 1762 to cause the system 1760 to control one or more aspects of equipment of the logging string 1740 and/or the logging truck 1750 and/or to acquire information from one or more pieces of equipment of the logging string 1740 and/or the logging truck 1750.

FIG. 17 also shows a workflow component 1770 that may be operatively coupled to the system 1760, one or more pieces of equipment in the environment 1701, to a client layer 1780 and/or to one or more networks, servers, etc.

As an example, the system 1760 can be operatively coupled to the client layer 1780. In the example of FIG. 17, the client layer 1780 can include features that allow for access and interactions via one or more private networks 1782, one or more mobile platforms and/or mobile networks 1784 and via the “cloud” 1786, which may be considered to include distributed equipment that forms a network such as a network of networks. As an example, the system 1760 can include circuitry to establish a plurality of connections (e.g., sessions). As an example, connections may be via one or more types of networks. As an example, connections may be client-server types of connections where the system 1760 operates as a server in a client-server architecture. For example, clients may log-in to the system 1760 and/or the workflow component 1770 where multiple clients may be handled, optionally simultaneously.

As an example, the field equipment system 1600 of FIG. 16 and/or the field equipment as in a field equipment system of FIG. 17 may be operatively coupled to a system that can implement a method such as, for example, the method 600 of FIG. 6, the method 910 of FIG. 9, the method 950 of FIG. 9, the method 1050 of FIG. 10, the method 1150 of FIG. 11, the method 1210 of FIG. 12, the method 1410 of FIG. 14, the method 1500 of FIG. 15, etc. As an example, such a system can include the workflow component 1680 of FIG. 16 and/or the workflow component 1770 of FIG. 17.

As an example, a system can include one or more computers, which may be, for example, portable computers such as a smart phone, a tablet computer, etc. In such an example, one or more applications (e.g., apps) may be operable at least in part via such portable computers in a manner that allows a user to create a workflow, modify a workflow, control a workflow, etc.

As an example, a system may be utilized to perform a workflow. Such a system may be distributed and allow for collaborative workflow interactions and may be considered to be a platform (e.g., a framework for collaborative interactions, etc.).

As an example, one or more systems can be utilized to implement a workflow that can be performed collaboratively. As an example, a system can be operated as a distributed, collaborative well-planning system. A system may utilize one or more servers, one or more client devices, etc. and may maintain one or more databases, data files, etc., which may be accessed and modified by one or more client devices, for example, using a web browser, remote terminal, etc. As an example, a client device may modify a database or data files on-the-fly, and/or may include “sandboxes” that may permit one or more client devices to modify at least a portion of a database or data files optionally off-line, for example, without affecting a database or data files seen by one or more other client devices. As an example, a client device that includes a sandbox may modify a database or data file after completing an activity in the sandbox.

In some examples, client devices and/or servers may be remote with respect to one another and/or may individually include two or more remote processing units. As an example, two systems can be “remote” with respect to one another if they are not physically proximate to one another; for example, two devices that are located at different sides of a room, in different rooms, in different buildings, in different cities, countries, etc. may be considered “remote” depending on the context. In some embodiments, two or more client devices may be proximate to one another, and/or one or more client devices and a server may be proximate to one another.

As an example, a method can include receiving domain specific language that expresses a model of a field equipment system that includes data acquisition equipment; compiling the domain specific language to executable code; and controlling at least a portion of the data acquisition equipment by executing the executable code.

As an example, a system can include a perforating gun where a domain specific language includes expressions for actuation of at least one charge using the perforating gun. As an example, a system can include a wireline where a domain specific language can include expressions for conveyance of the wireline in a bore in a geologic environment. As an example, a system can include an electric submersible pump where a domain specific language includes expressions for acquisition of data from a gauge operatively coupled to the electric submersible pump. In such an example, the system can include a drive operatively coupled to the electric submersible pump where the domain specific language includes expressions for control of the electric submersible pump via the drive.

As an example, a domain specific language can include expressions for regulatory compliance. As an example, a domain specific language can include sub-domain expressions. As an example, sub-domain expressions can include communication sub-domain expressions and data acquisition sub-domain expressions. As an example, sub-domain expressions can include control sub-domain expressions for control of at least a portion of equipment of a system at least in part via data acquired by a data acquisition equipment of the system.

As an example, a method can include modifying domain specific language to create modified domain specific language and compiling the modified domain specific language. In such an example, the modifying may include adding at least one expression for an additional piece of equipment added to the system.

As an example, controlling a data acquisition system can include tapping into at least one communication channel of a system.

As an example, a computing system can include a processor; memory operatively coupled to the processor; modules stored in the memory where the modules include processor-executable instructions where the instructions include instructions to instruct the system to: receive domain specific language that expresses a model of a field equipment system that includes data acquisition equipment; compile the domain specific language to executable code; and control at least a portion of the data acquisition equipment by executing the executable code. In such an example, the system can include at least one interface operatively coupled to the data acquisition equipment. As an example, modules can include at least one graphical user interface module that renders graphical representations of data acquisition equipment to a display where, for example, the graphical representations include associated domain specific language. As an example, a domain specific language can expresses model states that represent operational states of the field equipment system. For example, a model may be an instance of DSL where the model may take on one or more states, for example, as a workflow progresses. As an example, a state may be a state of a system, a state of a piece of equipment, etc. As an example, a system can include various states. As an example, a model may be expressed in DSL where the model represents a system that can be in one or more states. In such an example, the DSL may express one or more conditions for transitioning from one state to another state.

As an example, one or more computer-readable media can include computer-executable instructions executable a computing device where the instructions include instructions to instruct the computing device to: receive domain specific language that expresses a model of a field equipment system that includes data acquisition equipment; compile the domain specific language to executable code; and control at least a portion of the data acquisition equipment by executing the executable code. In such an example, the modules can include at least one communication module that compiles at least a portion of the domain specific language to executable code that controls communication along at least one communication channel of the field equipment system. As an example, the modules can include at least one sensor module that compiles at least a portion of the domain specific language to executable code that controls data acquisition by at least one sensor of the field equipment system.

As an example, a method can include receiving domain specific language that expresses a model of a field equipment system that includes data acquisition equipment; compiling the domain specific language to executable code; controlling at least a portion of the field equipment system by executing at least a portion of the executable code; and receiving data acquired by the data acquisition equipment responsive to executing at least a portion of the executable code.

As an example, a field equipment system can include a perforating gun where domain specific language includes expressions for actuation of at least one charge using the perforating gun.

As an example, a field equipment system can include a wireline where domain specific language includes expressions for conveyance of the wireline in a bore in a geologic environment.

As an example, a field equipment system can include an electric submersible pump where domain specific language includes expressions for acquisition of data from a gauge operatively coupled to the electric submersible pump. In such an example, the field equipment system can include a drive operatively coupled to the electric submersible pump where the domain specific language includes expressions for control of the electric submersible pump via the drive.

As an example, domain specific language can include expressions for regulatory compliance.

As an example, domain specific language can include sub-domain expressions. For example, where the sub-domain expressions include communication sub-domain expressions and data acquisition sub-domain expressions and/or where the sub-domain expressions include control sub-domain expressions for control of at least a portion of equipment of a field equipment system at least in part via data acquired by data acquisition equipment.

As an example, a method can include modifying domain specific language to create modified domain specific language and compiling the modified domain specific language. For example, modifying can include adding at least one expression for an additional piece of equipment added to a field equipment system.

As an example, controlling can include tapping into at least one communication channel of field equipment system and, for example, acquiring data via at least one of the at least one communication channel.

As an example, a computing system can include a processor; memory operatively coupled to the processor; and processor-executable instructions stored in the memory where the processor-executable instructions include instructions to instruct the system to: receive domain specific language that expresses a model of a field equipment system that includes data acquisition equipment; compile the domain specific language to executable code; control at least a portion of the field equipment system by execution of at least a portion of the executable code; and receive data from the data acquisition equipment responsive to execution of at least a portion of the executable code. In such an example, the computing system can include at least one interface operatively coupled to the data acquisition equipment. As an example, processor-executable instructions can include at least one set of graphical user interface instructions executable to render graphical representations of data acquisition equipment to a display. In such an example, one or more of the graphical representations can be associated with domain specific language.

As an example, a domain specific language can expresses model states that represent operational states of equipment in a field equipment system.

As an example, one or more computer-readable storage media can include computer-executable instructions that instruct a computing device to: receive domain specific language that expresses a model of a field equipment system that includes data acquisition equipment; compile the domain specific language to executable code; control at least a portion of the field equipment system by execution of at least a portion of the executable code; and receive data from the data acquisition equipment responsive to execution of at least a portion of the executable code. In such an example, the one or more computer-readable storage media can include communication compilation instructions that compile at least a portion of the domain specific language to executable code that controls communication along at least one communication channel of the field equipment system.

As an example, one or more computer-readable storage media can include sensor compilation instructions for at least one sensor that compile at least a portion of domain specific language to executable code that controls data acquisition by at least one sensor of a field equipment system.

As an example, a method may be implemented in part using computer-readable media (CRM), for example, as a module, a block, etc. that include information such as instructions suitable for execution by one or more processors (or processor cores) to instruct a computing device or system to perform one or more actions. As an example, a single medium may be configured with instructions to allow for, at least in part, performance of various actions of a method. As an example, a computer-readable medium (CRM) may be a computer-readable storage medium (e.g., a non-transitory medium) that is not a carrier wave and that is not a signal. In other words, a computer-readable storage medium is not transitory, not a carrier wave and not a signal.

According to an embodiment, one or more computer-readable media may include computer-executable instructions to instruct a computing system to output information for controlling a process. For example, such instructions may provide for output to sensing process, an injection process, drilling process, an extraction process, an extrusion process, a pumping process, a heating process, etc.

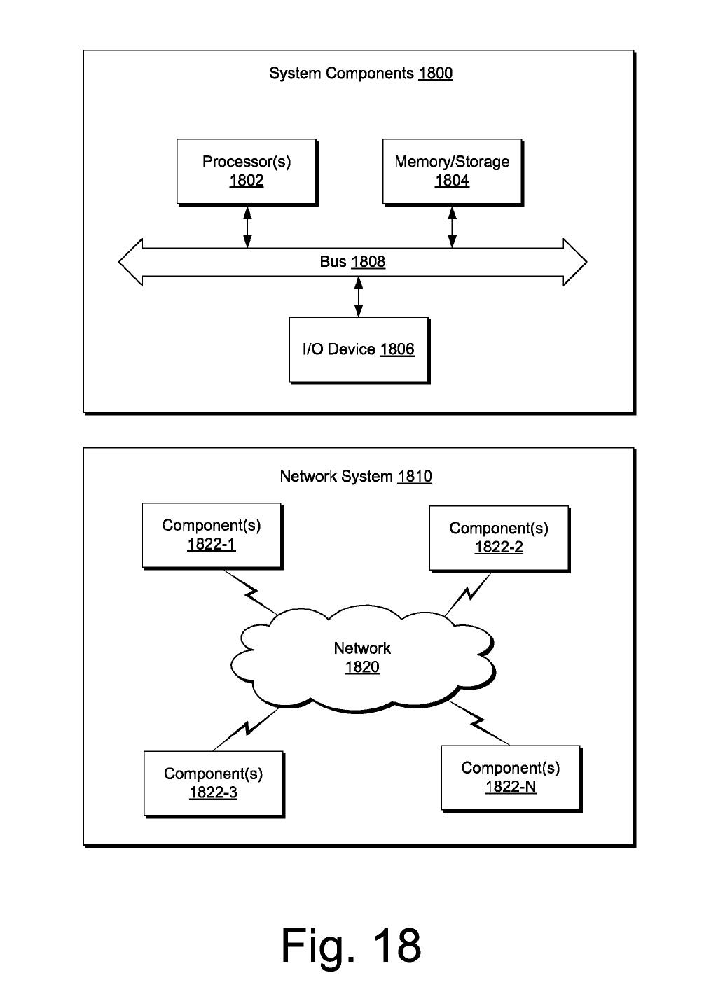

FIG. 18 shows components of a computing system 1800 and a networked system 1810. The system 1800 includes one or more processors 1802, memory and/or storage components 1804, one or more input and/or output devices 1806 and a bus 1808. According to an embodiment, instructions may be stored in one or more computer-readable media (e.g., memory/storage components 1804). Such instructions may be read by one or more processors (e.g., the processor(s) 1802) via a communication bus (e.g., the bus 1808), which may be wired or wireless. The one or more processors may execute such instructions to implement (wholly or in part) one or more attributes (e.g., as part of a method). A user may view output from and interact with a process via an I/O device (e.g., the device 1806). According to an embodiment, a computer-readable medium may be a storage component such as a physical memory storage device, for example, a chip, a chip on a package, a memory card, etc.

According to an embodiment, components may be distributed, such as in the network system 1810. The network system 1810 includes components 1822-1, 1822-2, 1822-3, . . . 1822-N. For example, the components 1822-1 may include the processor(s) 1802 while the component(s) 1822-3 may include memory accessible by the processor(s) 1802. Further, the component(s) 1802-2 may include an I/O device for display and optionally interaction with a method. A network 1820 may be or include one or more of the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words “means for” together with an associated function.

What is claimed is:

1. A method comprising:
receiving domain specific language that expresses a model of a field equipment system that comprises data acquisition equipment;
compiling the domain specific language to executable code;
controlling at least a portion of the field equipment system by executing at least a portion of the executable code; and
receiving data acquired by the data acquisition equipment responsive to executing at least a portion of the executable code.

2. The method of claim 1 wherein the field equipment system comprises a perforating gun and wherein the domain specific language comprises expressions for actuation of at least one charge using the perforating gun.

3. The method of claim 1 wherein the field equipment system comprises a wireline and wherein the domain specific language comprises expressions for conveyance of the wireline in a bore in a geologic environment.

4. The method of claim 1 wherein the field equipment system comprises an electric submersible pump and wherein the domain specific language comprises expressions for acquisition of data from a gauge operatively coupled to the electric submersible pump.

5. The method of claim 4 wherein the field equipment system comprises a drive operatively coupled to the electric submersible pump and wherein the domain specific language comprises expressions for control of the electric submersible pump via the drive.

6. The method of claim 1 wherein the domain specific language comprises expressions for regulatory compliance.

7. The method of claim 1 wherein the domain specific language comprises sub-domain expressions.

8. The method of claim 7 wherein the sub-domain expressions comprise communication sub-domain expressions and data acquisition sub-domain expressions.

9. The method of claim 7 wherein the sub-domain expressions comprise control sub-domain expressions for control of at least a portion of the field equipment system at least in part via data acquired by the data acquisition equipment.

10. The method of claim 1 comprising modifying the domain specific language to create modified domain specific language and compiling the modified domain specific language.

11. The method of claim 10 wherein modifying comprises adding at least one expression for an additional piece of equipment added to the field equipment system.

12. The method of claim 1 wherein the controlling comprises tapping into at least one communication channel of the field equipment system.

13. A computing system comprising:
a processor;
memory operatively coupled to the processor; and
processor-executable instructions stored in the memory wherein the processor-executable instructions comprise instructions to instruct the system to:
receive domain specific language that expresses a model of a field equipment system that comprises data acquisition equipment;
compile the domain specific language to executable code;
control at least a portion of the field equipment system by execution of at least a portion of the executable code; and
receive data from the data acquisition equipment responsive to execution of at least a portion of the executable code.

14. The computing system of claim 13 comprising at least one interface operatively coupled to the data acquisition equipment.

15. The computing system of claim 13 wherein the processor-executable instructions comprise at least one set of graphical user interface instructions executable to render graphical representations of data acquisition equipment to a display.

16. The computing system of claim 15 wherein the graphical representations comprise associated domain specific language.

17. The computing system of claim 13 wherein the domain specific language expresses model states that represent operational states of the field equipment system.

18. One or more computer-readable storage media comprising computer-executable instructions executable a computing device wherein the instructions comprise instructions to instruct the computing device to:
receive domain specific language that expresses a model of a field equipment system that comprises data acquisition equipment;
compile the domain specific language to executable code;
control at least a portion of the field equipment system by execution of at least a portion of the executable code; and
receive data from the data acquisition equipment responsive to execution of at least a portion of the executable code.

19. The one or more computer-readable storage media of claim 18 wherein the instructions comprise communication compilation instructions that compile at least a portion of the domain specific language to executable code that controls communication along at least one communication channel of the field equipment system.

20. The one or more computer-readable storage media of claim 18 wherein the instructions comprise sensor compilation instructions for at least one sensor that compile at least a portion of the domain specific language to executable code that controls data acquisition by at least one sensor of the field equipment system.
